(19) United States
(12) Patent Application Publication
(10) Pub. No.: US 2021/0279735 A1
(43) Pub. Date: Sep. 9, 2021

(54) INFORMATION PROCESSING DEVICE, INFORMATION PROCESSING SYSTEM, INFORMATION PROCESSING METHOD, AND PROGRAM

(71) Applicant: SONY CORPORATION, Tokyo (JP)

(72) Inventors: Taizo SHIRAI, Kanagawa (JP); Masatomo KURATA, Tokyo (JP); QiHong WANG, Tokyo (JP)

(73) Assignee: SONY CORPORATION, Tokyo (JP)

(21) Appl. No.: 16/334,556

(22) PCT Filed: Sep. 27, 2017
(86) PCT No.: PCT/JP2017/034885

§ 371 Date: Mar. 19, 2019

(30) Foreign Application Priority Data
Oct. 27, 2016 (JP) 2016-210454

(51) Int. Cl. G06Q 20/40; G06Q 20/10; G06Q 20/06

(52) U.S. Cl. CPC G06Q 20/40145; G06Q 20/065; G06Q 20/10

(57) ABSTRACT

A user authentication based on biometric information is performed and a remittance process is performed based on checking of the fact that a position or a behavior of a user satisfies a setting condition. In an information processing system including a user terminal and a process condition management server, the user terminal includes a control unit that performs a transaction with electronic money associated with a user account and transmits information acquired by a biometric information acquisition sensor and a positional sensor or a behavioral sensor to the process condition management server. The process condition management server performs user authentication based on biometric information, and determines whether the positional or behavioral information satisfies a setting condition, and causes a transaction process in accordance with a registered transaction aspect, for example, a remittance process to the user account to be performed when the positional or behavioral information satisfies the setting condition.

### TECHNICAL FIELD

The present disclosure relates to an information processing device, an information processing system, an information processing method, and a program, and more particularly, to an information processing device, an information processing system, an information processing method, and a program for performing a remittance process or the like based on checking of a position or a behavior of a user.

### BACKGROUND ART

In recent years, use of portable terminals such as cellular phones or smartphones with electronic money functions such as a charging function, a payment function, a settlement function, and a credit card function has increased.

By using portable terminals with electronic money functions, it is possible to simply perform settlement of shopping or the like without carrying cash.

In a settlement process using electronic money, in many cases, a portable terminal such as a smartphone with electronic money functions is generally brought close to a settlement device, short range communication is performed between the portable terminal and the settlement device to perform an authentication process, and a process is performed on the condition that authentication is established.

Note that as an example of technology of the related art disclosing electronic commerce involving an authentication process, there is Patent Literature 1 (JP 3951920B).

Use forms of electronic money until now have been limited to use of electronic money by only users themselves carrying portable terminals with electronic money functions in many cases.

For example, specific agreements or processes have not been prescribed with regard to a remittance process between a plurality of users using electronic money such as remittance of money of electronic money accounts of parents to electronic money accounts of children.

In addition, as described above, when short range communication is performed between the portable terminal and the settlement device to perform an authentication process and a process is performed on the condition that authentication is established, there is a problem in that it is troublesome to users.

### CITATION LIST

### Patent Literature

Patent Literature 1: JP 3951920B

### DISCLOSURE OF INVENTION

### Technical Problem

The present disclosure is devised, for example, in view of the above-described problem and an object of the present disclosure is to provide an information processing device, an information processing system, an information processing method, and a program performing a remittance process between users using portable terminals or use control.

An object of an embodiment of the present disclosure is to provide an information processing device, an information processing system, an information processing method, and a program performing a remittance process or use control in accordance with, for example, a position or a behavior of a user.

### Solution to Problem

A first aspect of the present disclosure resides in an information processing device including: a control unit configured to perform a transaction with electronic money associated with a user account; a biometric information acquisition sensor configured to acquire biometric information; and a positional sensor or a behavioral sensor configured to acquire positional information or behavioral information. The control unit transmits the information acquired by the biometric information acquisition sensor and the positional sensor or the behavioral sensor to a process condition management server and receives, via the communication unit, a result of a transaction process with electronic money performed on conditions (a) and (b) below: (a) checking that user authentication based on the biometric information in the process condition management server is established; and (b) checking that the positional information or the behavioral information satisfies a setting condition retained in the process condition management server.

Further, a second aspect of the present disclosure resides in an information processing device including: a communication unit configured to perform communication with a user terminal that performs a transaction with electronic money associated with a user account; and a data processing unit configured to perform data processing to which data received from the user terminal via the communication unit is applied. The data processing unit performs user authentication based on biometric information received from the user terminal. In a case in which the user authentication is established, the data processing unit determines whether or not positional information or behavioral information received from the user terminal satisfies a setting condition registered in a storage unit, and performs a remittance process to the user account or a payment process from the user account or outputs a request for a transaction process to a process execution server in accordance with a transaction aspect registered in advance on the basis of the determination of the satisfaction.

Further, a third aspect of the present disclosure resides in an information processing system including: a user terminal; and a process condition management server. The user terminal includes a control unit that performs a transaction with electronic money associated with a user account, a biometric information acquisition sensor that acquires biometric information, and a positional sensor or a behavioral sensor that acquires positional information or behavioral information. The control unit performs a process of transmitting the information acquired by the biometric information acquisition sensor and. the positional sensor or the behavioral sensor to the process condition management server. The process condition management server performs user authentication based on the biometric information received from the user terminal. In a case in which the user authentication is established, the process condition management server determines whether or not positional information or behavioral information received from the user terminal satisfies a setting condition registered in a storage unit, and performs a remittance process to the user account or a payment process from the user account or outputs a request for a transaction process in accordance with a transaction aspect registered in advance to a process execution server on the basis of the determination of the satisfaction.

Further, a fourth aspect of the present disclosure resides in an information processing system including: a user terminal; a process condition management server; and a process execution server. The user terminal includes a control unit that performs a transaction with electronic money associated with a user account, a biometric information acquisition sensor that acquires biometric information, and a positional sensor or a behavioral sensor that acquires positional information or behavioral information. The control unit performs a process of transmitting the information acquired by the biometric information acquisition sensor and the positional sensor or the behavioral sensor to the process condition management server. The process condition management server performs user authentication based on the biometric information received from the user terminal. In a case in which the user authentication is established, the process condition management server determines whether or not positional information or behavioral information received from the user terminal satisfies a setting condition registered in a storage unit, and outputs a request for a transaction process in accordance with a transaction aspect registered in advance to a process execution server on the basis of the determination of the satisfaction. The process execution server performs a remittance process to the user account or a payment process from the user account in accordance with the transaction aspect registered in advance in response to reception of the request for performing the transaction process from the process condition management server.

Further, a fifth aspect of the present disclosure resides in an information processing method performed by an information processing device. The information processing device includes a control unit configured to perform a transaction with electronic money associated with a user account, a biometric information acquisition sensor configured to acquire biometric information, and a positional sensor or a behavioral sensor configured to acquire positional information or behavioral information. The control unit transmits the information acquired by the biometric information acquisition sensor and the positional sensor or the behavioral sensor to a process condition management server and receives, via the communication unit, a result of a transaction process with electronic money performed on conditions (a) and (b) below: (a) checking that user authentication based on the biometric information in the process condition management server is established; and (b) checking that the positional information or the behavioral information satisfies a setting condition retained in the process condition management server.

Further, a sixth aspect of the present disclosure resides in a program causing an information processing device to perform information processing. The information processing device includes a control unit configured to perform a transaction with electronic money associated with a user account, a biometric information acquisition sensor configured to acquire biometric information, and a positional sensor or a behavioral sensor configured to acquire positional information or behavioral information. The program causes the control unit to control a process of transmitting the information acquired by the biometric information acquisition sensor and the positional sensor or the behavioral sensor to a process condition management server and a process of receiving, via the communication unit, a result of a transaction process with electronic money performed on conditions (a) and (b) below: (a) checking that user authentication based on the biometric information in the process condition management server is established; and (b) checking that the positional information or the behavioral information satisfies a setting condition retained in the process condition management server.

Note that a program according to the present disclosure is, for example, a program provided in computer-readable format to an information processing apparatus or a computer system capable of executing various program code, the program being providable by a storage medium or communication medium. By providing such a program in a computer-readable format, processing corresponding to the program is performed on the information processing apparatus or the computer system.

Further objectives, features, and advantages of the present disclosure will be clarified by a more detailed description based on the embodiments of the present disclosure described hereinafter and the attached drawings. Note that in this specification, the term “system” refers to a logical aggregate configuration of multiple devices, and the respective devices of the configuration are not limited to being inside the same housing.

### Advantageous Effects of Invention

According to a configuration of an embodiment of the present disclosure, a configuration in which user authentication based on biometric information is performed and a remittance process is performed on the basis of checking that a position or a behavior of a user satisfies a setting condition is realized. Specifically, for example, in an information processing system including a user terminal and a process condition management server, the user terminal includes a control unit that performs a transaction with electronic money associated with a user account and transmits information acquired by a biometric information acquisition sensor and a positional sensor or a behavioral sensor to the process condition management server. The process condition management server performs user authentication based on biometric information, and further determines whether or not the positional or behavioral information satisfies a setting condition, and causes a transaction process in accordance with a registered transaction aspect, for example, a remittance process to the user account to be performed in a case in which the positional or behavioral information satisfies the setting condition.

In the configuration, a configuration in which the user authentication based on the biometric information is performed and the remittance process is realized on the basis that it is checked that a position or a behavior of a user satisfies the setting condition is realized.

Note that the advantageous effects described in the present specification are merely exemplary and are not limited, and additional advantageous effects may be achieved.

### BRIEF DESCRIPTION OF DRAWINGS

FIG. 1 is an explanatory diagram illustrating an overview of an information processing system according to the present disclosure.

FIG. 2 is an explanatory diagram illustrating an overview of an information processing system according to the present disclosure.

FIG. 3 is an explanatory diagram illustrating an example of user information retained in a process condition management server.

FIG. 4 is an explanatory diagram illustrating an example of user information retained in a process execution server.

FIG. 5 is an explanatory diagram illustrating an overview of an information processing system according to the present disclosure.

FIG. 6 is an explanatory diagram illustrating a process condition registration sequence.

FIG. 7 is an explanatory diagram illustrating specific examples of process conditions.

FIG. 8 is an explanatory diagram illustrating a sequence of a remittance process based on checking of a position or a behavior of a user.

FIG. 9 is an explanatory diagram illustrating a sequence of a remittance process based on checking of a position or a behavior of a user.

FIG. 10 is an explanatory diagram illustrating specific examples of process conditions.

FIG. 11 is an explanatory diagram illustrating a sequence of a remittance process based on checking of a position or a behavior of a user.

FIG. 12 is an explanatory diagram illustrating a sequence of a remittance process based on checking of a position or a behavior of a user.

FIG. 13 is an explanatory diagram illustrating a specific example of a remittance process based on checking of a position or a behavior of a user.

FIG. 14 is an explanatory diagram illustrating specific examples of process conditions.

FIG. 15 is an explanatory diagram illustrating a process between each server and an application performed by a user terminal.

FIG. 16 is an explanatory diagram illustrating an overview of an information processing system according to the present disclosure.

FIG. 17 is an explanatory diagram illustrating examples of user information retained in a service supply server.

FIG. 18 is an explanatory diagram illustrating a process condition registration sequence.

FIG. 19 is an explanatory diagram illustrating specific examples of process conditions.

FIG. 20 is an explanatory diagram illustrating a sequence of a remittance process based on checking of a position or a behavior of a user.

FIG. 21 is an explanatory diagram illustrating a sequence of a remittance process based on checking of a position or a behavior of a user.

FIG. 22 is an explanatory diagram illustrating specific examples of process conditions.

FIG. 23 is an explanatory diagram illustrating an embodiment in which a service supply server is a server of a leisure facility management company.

FIG. 24 is an explanatory diagram illustrating specific examples of process conditions.

FIG. 25 is an explanatory diagram illustrating a specific example of an information processing device configured as a user terminal.

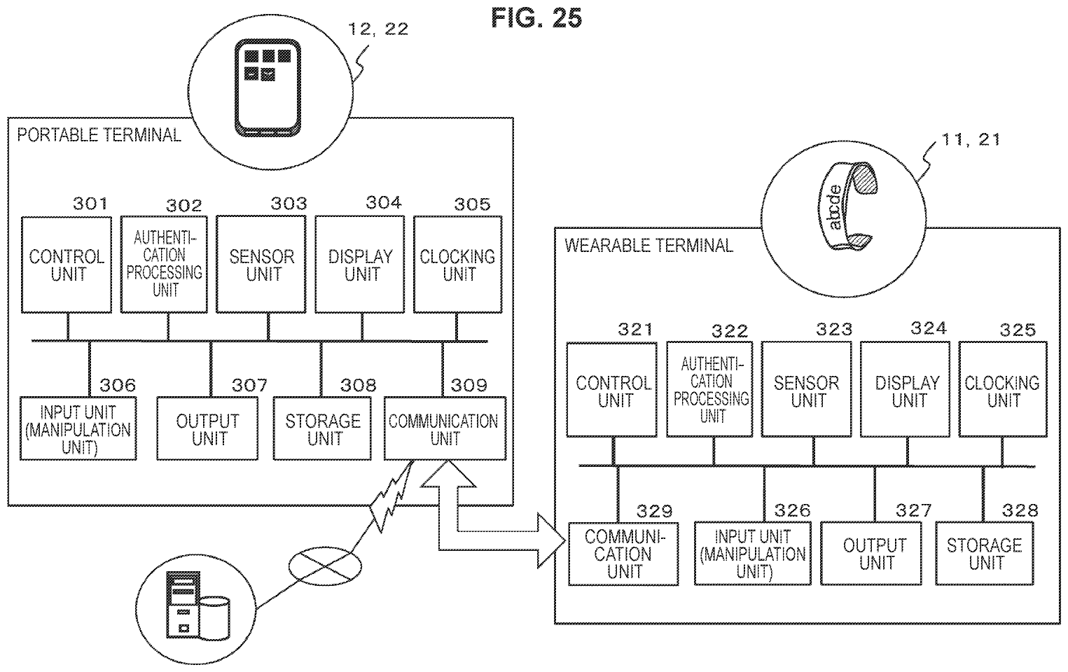

FIG. 26 is an explanatory diagram illustrating a specific hardware example of an information processing device configured as a server.

### MODE(S) FOR CARRYING OUT THE INVENTION

Hereinafter, the details of an information processing device, an information processing system, an information processing method, and a program according to the present disclosure will be described with reference to the drawings. Note that the following items will be described.
1. Specific example of information processing system
2. Embodiment in which remittance control between user accounts is performed in accordance with position or behavior of user
3. Embodiment in which remittance control of service price payment is performed in accordance with position or behavior of user
4. Configuration example of information processing device
5. Conclusion of configuration according to present disclosure

### 1. Specific Example of Information Processing System

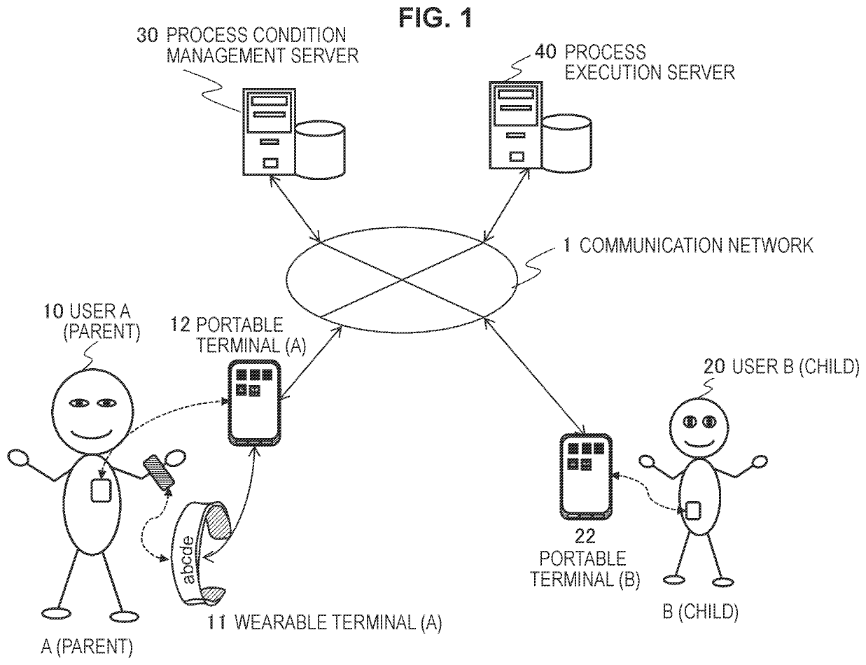

First, a specific example of an information processing system according to the embodiment will be described with reference to FIG. 1 and subsequent drawings.

FIG. 1 is an explanatory diagram illustrating a configuration example of the information processing system according to the present disclosure.

FIG. 1 illustrates a user A (parent) 10 and a user B (child) 20 with a parent-child relation.

The user A (parent) 10 mounts a wristband type wearable terminal (A) on his or her arm and keeps a portable terminal (A) 12 in his or her chest pocket.

Both the wearable terminal (A) 11 and the portable terminal (A) 12 include, for example, a control unit that performs transactions with electronic money associated with user accounts of a financial institution such as a bank and further includes a biometric information acquisition sensor that acquires biometric information and a positional sensor or a behavioral sensor that acquires positional information or behavioral information. In addition, the wearable terminal (A) 11 and the portable terminal (A) 12 are each an information processing device that includes a display unit, a communication unit, and a data processing unit performing various other applications or data processing.

The wearable terminal (A) 11 and the portable terminal (A) 12 each have a configuration for perforating mutual communication. For example, the wearable terminal (A) 11 and the portable terminal (A) 12 perform data communication in conformity with the Bluetooth (registered trademark) low energy (BLE) standard which is a low power consumption type Bluetooth (registered trademark) (BT: Bluetooth (registered trademark)) communication.

The portable terminal (A) 12 further has a configuration capable of performing communication with various external devices, for example, a server connected to a network 1 or other user terminals, via the network 1 such as the Internet through communication.

The user B (child) 20 keeps a portable terminal (B) 22 in his or her pocket.

The portable terminal (B) 22 also includes, for example, a control unit that performs transactions with electronic money associated with user accounts of a financial institution such as a bank and further includes a biometric information acquisition sensor that acquires biometric information and a positional sensor or a behavioral sensor that acquires positional information or behavioral information. In addition, the portable terminal (B) 22 is an information processing device that includes a display unit, a communication unit, and a data processing unit performing various other applications or data processing.

The portable terminal (B) 22 also has a configuration capable of performing communication with various external devices, for example, a server connected to a network 1 or other user terminals, via the network 1 such as the Internet through Wi-Fi communication.

A process condition management server 30 and a process execution server 40 are further connected to the network 1.

The process condition management server 30 stores, for example, process condition information such as a setting condition which is a condition that a remittance process is performed from an account (a banking account, an electronic money account, or the like) of the user A (parent) 10 to an account (a banking account, an electronic money account, or the like) of the user B (child) 20 in a storage unit (database). The process condition management server 30 further performs a process of determining whether or not the setting condition retained in the storage unit is satisfied.

The process of determining whether or not the setting condition is satisfied is performed on the basis of, for example, positional information or behavioral information of the user B (child) transmitted from the portable terminal (B) 22 of the user B (child) 20.

Note that the determination process is performed using positional information or behavioral information of the user A (parent) transmitted from the portable terminal (A) 11 of the user A (parent) 10 in some cases.

The process execution server 40 is, for example, a server that is managed by a bank and performs, for example, a remittance process from an account (a banking account, an electronic money account, or the like) of the user A (parent) 10 to an account (a banking account, an electronic money account, or the like) of the user B (child) 20.

For example, in a case in which a setting condition for performing the remittance process is determined to be satisfied on the basis of the positional information or the behavioral information of the user B (child) transmitted from the portable terminal (B) 22 of the user B (child) 20, the process condition management server 30 requests the process execution server 40 to perform the remittance process.

The process execution server 40 performs the remittance process in response to reception of the remittance request from the process condition management server 30.

Note that, although the process condition management server 30 and the process execution server 40 are illustrated as separate servers in FIG. 1, these two servers may be configured to be integrated as one server that performs functions of each server.

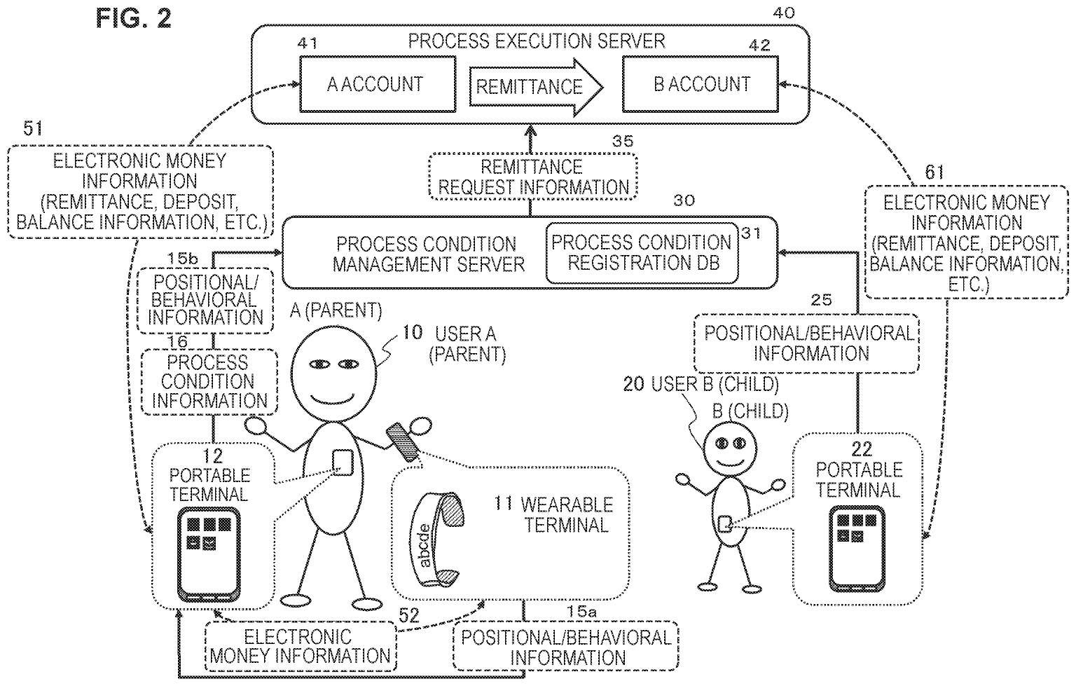

FIG. 2 is an explanatory diagram illustrating an overview of a communication process performed between each user terminal and each server.

The wearable terminal (A) 11 or the portable terminal (A) 12 of the user A (parent) 10 includes a sensor (a GPS sensor, an acceleration sensor, or the like) that acquires positional information or behavioral information. Positional information/behavioral information 15 of the user A (parent) 10 which is information acquired by the sensor is transmitted to the process condition management server 30.

In addition, the user A (parent) 10 uses the portable terminal (A) 12 to transmit process condition information 16 such as a setting condition for performing the remittance process to the process condition management server 30.

The user A (parent) 10 can input the process condition information 16 to the portable terminal (A) 12.

The process condition management server 30 stores the process condition information 16 received from the portable terminal (A) 12 in a process condition registration database (DB) 31.

A specific condition setting example will be described below.

The portable terminal (B) 22 of the user B (child) 20 also includes a sensor (a GPS sensor, an acceleration sensor, or the like) that acquires positional information or behavioral information. Positional information/behavioral information 25 of the user B (child) 20 which is information acquired by the sensor is transmitted to the process condition management server 30.

In addition, for example, the process execution server 40 that is managed by a bank manages accounts (bank accounts or electronic money accounts) 41 and 42 of the user A (parent) 10 and the user B (child) 20 and performs a remittance process between these accounts.

The portable terminal (A) 12 of the user A (parent) 10 performs communication with the process execution server 40 that is managed by a bank, can acquire and display electronic money information 51, for example, remittance information, reception information, and balance information, regarding the account 41 of A, and can make a process request such as a remittance request.

The wearable terminal (A) 11 of the user A (parent) 10 performs communication with the process execution server 40 via the portable terminal (A) 12 and can transmit a process request or a process of acquiring the electronic money information 51 regarding the account 41 of A.

The portable terminal (B) 22 of the user B (child) 20 also performs communication with the process execution server 40 that is managed by a bank, can acquire and display electronic money information 61, for example, remittance information, reception information, and balance information, regarding the account 42 of B, and can make a process request such as a remittance request.

For example, in a case in which an actual remittance process condition (a setting condition) registered in the process condition registration database 31 is determined to be satisfied on the basis of the positional information or the behavioral information of the user B (child) transmitted from the portable terminal (B) 22 of the user B (child) 20, the process condition management server 30 outputs remittance process request information to the process execution server 40.

Remittance request information 35 is illustrated in the drawing.

The remittance request information 35 includes designation information of a remittance amount of money or information regarding a remittance source, a remittance destination (reception destination), or the like.

The process execution server 40 performs a remittance process from the A account 41 which is an account of the user A (parent) 10 to the B account 42 which is an account of the user B (child) 20 in response to reception of the remittance request information 35 from the process condition management server 30.

When the remittance process is performed, the electronic money information 51 and 61 is transmitted to the portable terminal (A) 12 of the user A (parent) 10 or the portable terminal (B) 22 of the user B (child) 20.

Note that, in a case in which data communication between the wearable terminal (A) 11 or the portable terminal (A) 12 of the user A (parent) 10 and the process condition management server 30 or the process execution server 40 is performed, an authentication process is performed. Each of the servers 30 and 40 performs a process of checking that a user using the wearable terminal (A) 11 or the portable terminal (A) 12 is the user A (parent) 10 (a user authentication process).

After the user authentication is established and it is checked that the user using the wearable terminal (A) 11 or the portable terminal (A) 12 is the user A (parent) 10, a data communication process for various kinds of information (the positional/behavioral information 15, the process condition information 16, the electronic money information 51, and the like) is started.

When the user authentication is not established, the communication process for the information (the positional/behavioral information 15, the process condition information 16, the electronic money information 51, and the like) is not performed.

Similarly, even in a case in which data communication between the portable terminal (B) 22 of the user B (child) 20 and the process condition management server 30 or the process execution server 40 is performed, an authentication process is also performed. Each of the servers 30 and 40 performs a process of checking that a user using the portable terminal (B) 22 is the user B (child) 20 (a user authentication process).

After the user authentication is established and it is checked that the user using the portable terminal (B) 22 is the user B (child) 20, a data communication process for various kinds of information (the positional/behavioral information 25, the electronic money information 61, and the like) is started.

When the user authentication is not established, the communication process for the information (the positional/behavioral information 25, the electronic money information 61, and the like) is not performed.

Note that, as the user authentication process, a biometric authentication process of applying biometric information of the user is performed. For example, biometric authentication such as fingerprint authentication, vein authentication, face authentication, iris authentication, blood vessel authentication, or voiceprint authentication achieved using biometric information by which a user can be specified is performed.

Note that it is preferable to perform the authentication process as a so-called “continuous authentication process” that is performed before start of data communication and is performed periodically during execution of the data communication.

This is, for example, to prevent dishonest acts such as the user who uses the portable terminal or the wearable terminal changing.

In a case in which the “continuous authentication process” is performed, for example, the wearable terminal (A) 11 or the portable terminal (A) 12 and the portable terminal (B) 22 continuously transmit biometric authentication information (for example, blood vessel information or the like) registered in advance to the server (the process execution condition management server 30 or the process execution server 40) which is a communication partner.

The server (the process execution condition management server 30 or the process execution server 40) periodically performs a collation process with registered information on the basis of biometric information received from the user terminal which is the communication partner, and performs a process of continuing the communication in the case of establishment of the collation and blocking the communication in the case of non-establishment of the collation.

By performing such continuous authentication, it is possible to prevent the user who uses the user terminal of the communication partner from changing.

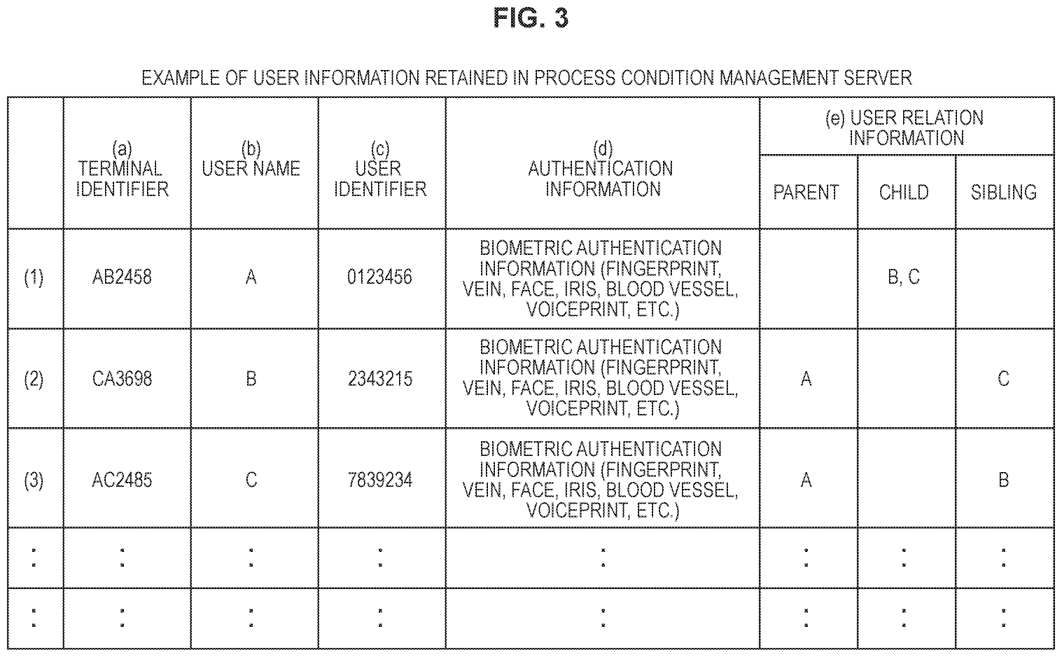

Next, an example of the user information retained by the process condition management server 30 will be described with reference to FIG. 3.

As illustrated in FIG. 3, the process condition management server 30 retains correspondent information of all of the following data as user information in the storage unit:

(a) terminal identifier;

(b) user name;

(c) user identifier (ID);

(d) user authentication information; and

(e) user relation information.

The (a) terminal identifier is an identifier (ID) specific to a terminal.

The (b) user name is a name or a nickname of a user.

The (c) user identifier (ID) is an identifier specific to an individual user.

The (d) user authentication information is biometric authentication information and is preferably set to information which can be applied to the continuous authentication process. For example, biometric authentication information such as a fingerprint, a vein, a face, an iris, a blood vessel, or a voiceprint is received from a user and registered in advance.

The process condition management server 30 uses the registered information to perform a collation process with biometric information received from a communication partner and performs the authentication process.

The (e) user relation information is information indicating a relation between a registered user and another registered user, for example, a parent-child relation or a sibling relation. In a case in which the remittance process is performed, this information is used as information for a process of checking a remittance source and a remittance destination or checking whether remittance is remittance within an allowable remittance range applied in advance.

For example, the user A (parent) 10 can perform a process of setting various remittance conditions and can register a remittance amount, a remittance source, a remittance destination, and various setting conditions required to be checked to perform remittance in the process condition management server 30.

Examples of specific process conditions will be described in a later section.

Note that the biometric authentication information (for example, blood vessel information or the like) acquired in advance may be stored in the storage unit of the wearable terminal (A) 11 or the portable terminal (A) 12 and the portable terminal (B) 22, the wearable terminal (A) 11 or the portable terminal (A) 12 and the portable terminal (B) 22 may perform an authentication process of collating biometric information newly acquired from the user with the biometric information stored in the storage unit, and only an authentication result, that is, an authentication result of authentication establishment or authentication non-establishment, may be transmitted to the process condition management server 30.

By performing such setting, for example, it is possible to efficiently perform the “continuous authentication process” performed periodically in a short time and it is possible to reduce an amount of communication data with the server.

Note that, in this configuration, to prevent falsification, the biometric authentication information stored in the storage unit in the wearable terminal (A) 11 or the portable terminal (A) 12 and the portable terminal (B) 22 is preferably, for example, subjected to a checking process in advance by the process condition management server 30 to be set to data to which signature of the process condition management server 30 is assigned.

In addition, the biometric information or the authentication result data which is data transmitted to and received from the process condition management server 30 is preferably configured to prevent leakage using a predetermined cryptographic communication protocol.

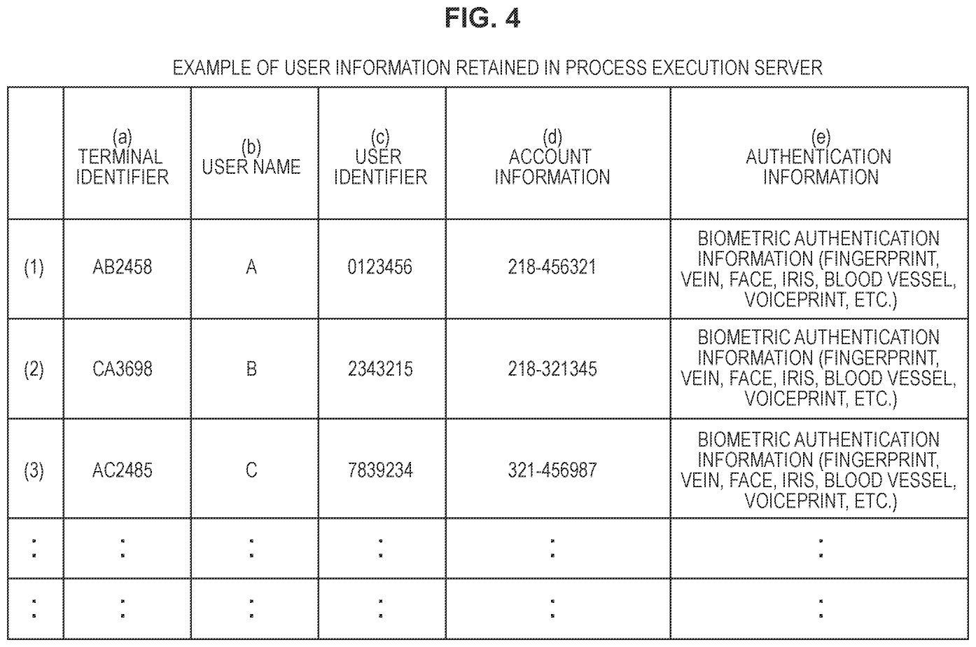

Next, an example of the user information retained in the process execution server 40 will be described with reference to FIG. 4.

As illustrated in FIG. 4, the process execution server 40 retains correspondent information of all of the following data as user information in the storage unit:

(a) terminal identifier;

(b) user name;

(c) user identifier (ID);

(d) account information; and

(e) user authentication information.

The (a) terminal identifier is an identifier (ID) specific to a terminal.

The (b) user name is a name or a nickname of a user.

The (c) user identifier (ID) is an identifier specific to an individual user.

The (d) account information is account information of each user. Any one of bank account information and electronic money account information may be used. Here, in any case, an account on which a process (remittance, reception, balance check, or the like) can be performed in response to a process request from the user terminal is necessary. In the case of a bank account, an account associated with electronic money which can be used in a user terminal is necessary.

The (e) user authentication information is biometric authentication information and is preferably set to information which can be applied to the continuous authentication process. For example, biometric authentication information such as a fingerprint, a vein, a face, an iris, a blood vessel, or a voiceprint is received from a user and registered in advance.

The process execution server 40 uses the registered information to perform a collation process with biometric information received from a communication partner and performs the authentication process.

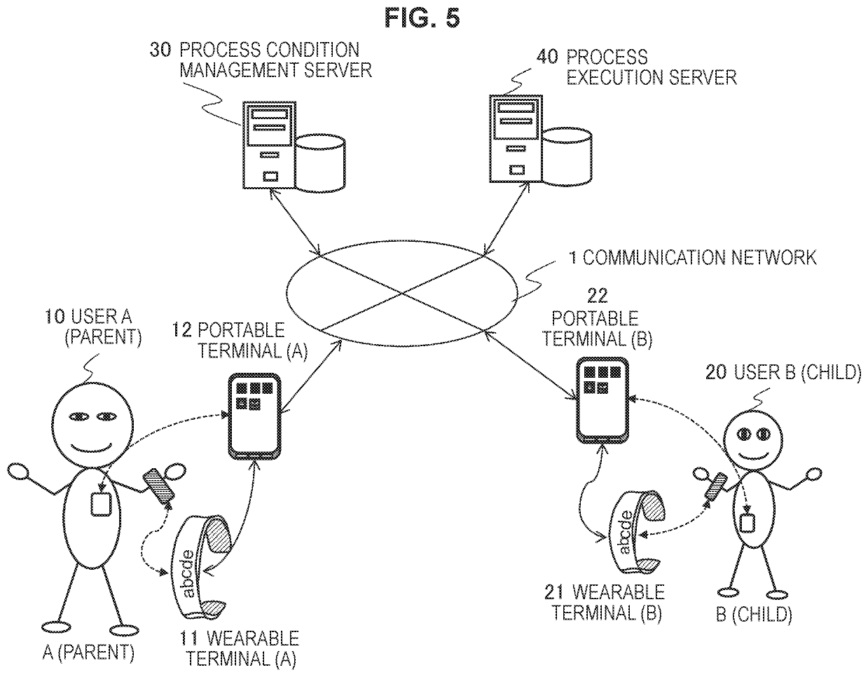

Note that, in the example described with reference to FIGS. 1 and 2. the configuration in which the user A (parent) 10 carries the wearable terminal (A) 11 and the portable terminal (A) 12 and the user B (child) 20 carries only the portable terminal (B) 22 has been described. However, as illustrated in FIG. 5, a configuration in which the user B (child) 20 carries a wearable terminal (B) 21 and the portable terminal (B) 22 like the user A (parent) 10 may be realized.

The wearable terminal (B) 21 of the user B (child) 20 performs data communication in conformity with the Blutooth (registered trademark) low energy (BLE) standard which is a low power consumption type Bluetooth (registered trademark) (BT: Bluetooth (registered trademark)) communication with the portable terminal (B) 22 of the user B (child) 20.

The portable terminal (B) further has a configuration capable of performing communication with various communication devices, for example, a server connected to the network 1 or other user terminals, via the network 1 such as the Internet through Wi-Fi communication.

### 2. Embodiment in which Remittance Control Between User Accounts is Performed in Accordance with Position or Behavior of User

Next, an embodiment in which remittance control between user accounts is performed in accordance with a position or a behavior of a user will be described.

The embodiment to be described below is, for example, an embodiment in which remittance is performed from the account of the user A (parent) 10 managed by the process execution server 40 to the account of the user B (child) 20 in the setting illustrated in FIG. 1.

The remittance process is performed in a case in which the user A (parent) 10 satisfies a setting condition registered in the process condition management server 30.

The process condition management server 30 determines whether or not the user A (parent) 10 satisfies a setting condition registered in the process condition management server 30.

The process condition management server 30 acquires positional information or behavioral information of the user B (child) 20 from, for example, the portable terminal (9) 22 of the user B (child) 20 and performs a process of determining whether or not a remittance condition is satisfied on the basis of the acquired information.

In a case in which a remittance process condition is determined to be satisfied, the process condition management server 30 transmits a request (permission) message for the remittance process to the process execution server 40.

In response to reception of the request (permission) message for the remittance process, the process execution server 40 performs a remittance process from the account of the user A (parent) 10 managed by the process execution server 40 to the account of the user B (child) 20.

Hereinafter, the series of processes will be described.

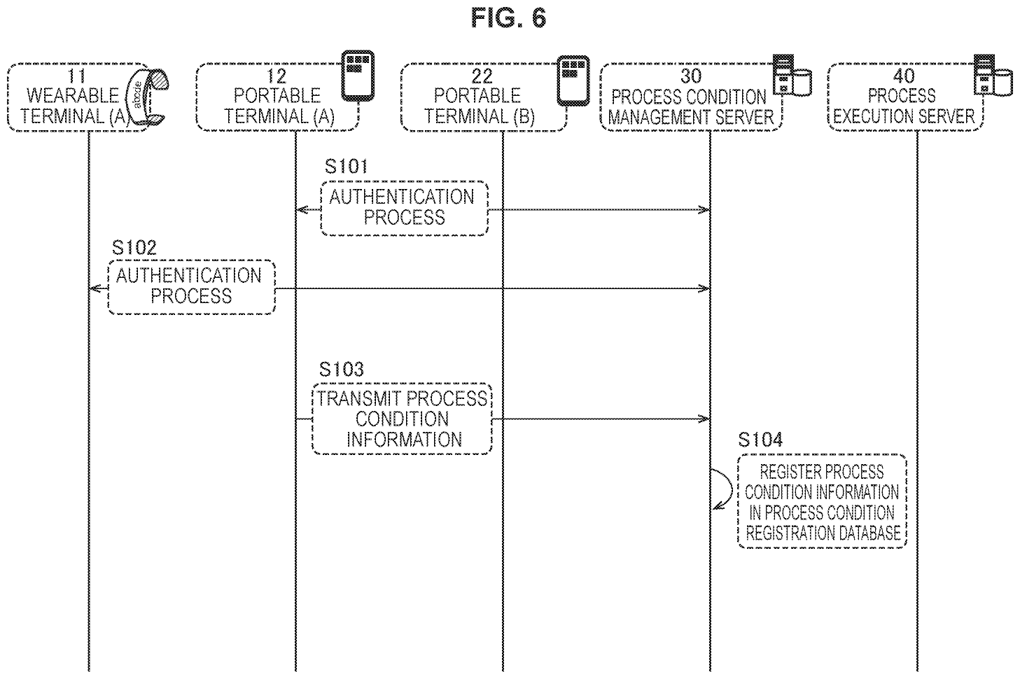

First, a process sequence of a process in which the user A (parent) 10 registers a remittance process condition in the process condition management server 30 will be described with reference to the sequence diagram illustrated in FIG. 6.

In FIG. 6, each of the following devices is illustrated from the left:

the wearable terminal (A) 11 of the user A (parent) 10;

the portable terminal (A) 12 of the user A (parent) 10;

the portable terminal (B) 22 of the user B (child) 20;

the process condition management server 30; and

the process execution server 40.

Hereinafter, process steps of the sequence diagram illustrated in FIG. 6 will be described in sequence.

### (Step S101)

First, an authentication process is performed between the portable terminal (A) 12 of the user A (parent) 10 and the process condition management server 30.

The authentication process is an authentication process of checking reliability of both the devices and authenticating the user A (parent) 10 who is the user of the portable terminal (A) 12 for user authentication.

The user authentication process is performed using authentication information which is the data retained in the process condition management server 30 and described above with reference to FIG. 3.

The portable terminal (A) 12 of the user A (parent) 10 reads the biometric information of the user A (parent) 10 and transmits the read biometric information to the process condition management server 30.

The process condition management server 30 performs a process of collating the biometric information received from the portable terminal (A) 12 with registration authentication information which is the data retained in the process condition management server 30 and described above with reference to FIG. 3.

When the collation is established, that is, the received data agrees with the registered data, the user of the portable terminal (A) 12 is determined to be the user A (parent) 10 and the authentication is determined to be established, and then the process proceeds to a subsequent process.

Conversely, in a case in which the collation is not established, that is, the received data does not agree with the registered data, the user of the portable terminal (A) 12 is determined not to be the user A (parent) 10 and the authentication is determined not to be established, and then the process is stopped without proceeding to a subsequent process. Note that, in this case, the process condition management server 30 may notify the portable terminal (A) 12 of an error message for reporting that the authentication has not been established.

### (Step S102)

When the authentication process of step S101 is established, an authentication process is subsequently performed between the wearable terminal (A) 11 of the user A (parent) 10 and the process condition management server 30.

Note that this process is a process necessary in a case in which data communication with the process condition management server 30 is performed using the wearable terminal (A) 11. A case in which the data communication with the process condition management server 30 is not performed using the wearable terminal (A) 11 can be omitted.

In step S102, an authentication process is performed between the wearable terminal (A) 11 of the user A (parent) 10 and the process condition management server 30.

The authentication process is an authentication process of checking reliability of both the devices and authenticating the user A (parent) 10 who is the user of the wearable terminal (A) 11 for user authentication.

The user authentication process is performed using authentication information which is the data retained in the process condition management server 30 and described above with reference to FIG. 3.

The wearable terminal (A) 11 of the user A (parent) 10 reads the biometric information of the user A (parent) 10 and transmits the read biometric information to the process condition management server 30.

The process condition management server 30 receives the biometric information read by the wearable terminal (A) 11 via the portable terminal (A) 12 for which the authentication process has already been completed and performs a process of collating the received biometric information with the registration authentication information which is the data retained in the process condition management server 30 and described above with reference to FIG. 3.

When the collation is established, that is, the received data agrees with the registered data, the user of the wearable terminal (A) 11 is determined to be the user A (parent) 10 and the authentication is determined to be established, and then the process proceeds to a subsequent process.

Conversely, when the collation is not established, that is, the received data does not agree with the registered data, the user of the wearable terminal (A) 11 is determined not to be the user A (parent) 10 and the authentication is determined not to be established, and then the process is stopped without proceeding to a subsequent process. Note that, in this case, the process condition management server 30 may notify the wearable terminal (A) 11 or the portable terminal (A) 12 of an error message for reporting that the authentication has not been established.

### (Step S103)

Subsequently, the user A (parent) 10 inputs process condition information to the portable terminal (A) 12 to transmit the process condition information to the process condition management server 30.

That is, a setting condition which is a condition for determining whether or not to perform a remittance process from the account of the user A (parent) 10 or process condition information including a remittance amount, a remitter (remittance source), a receiver (remittance destination), and the like is input to the portable terminal (A) 12 to be transmitted to the process condition management server 30.

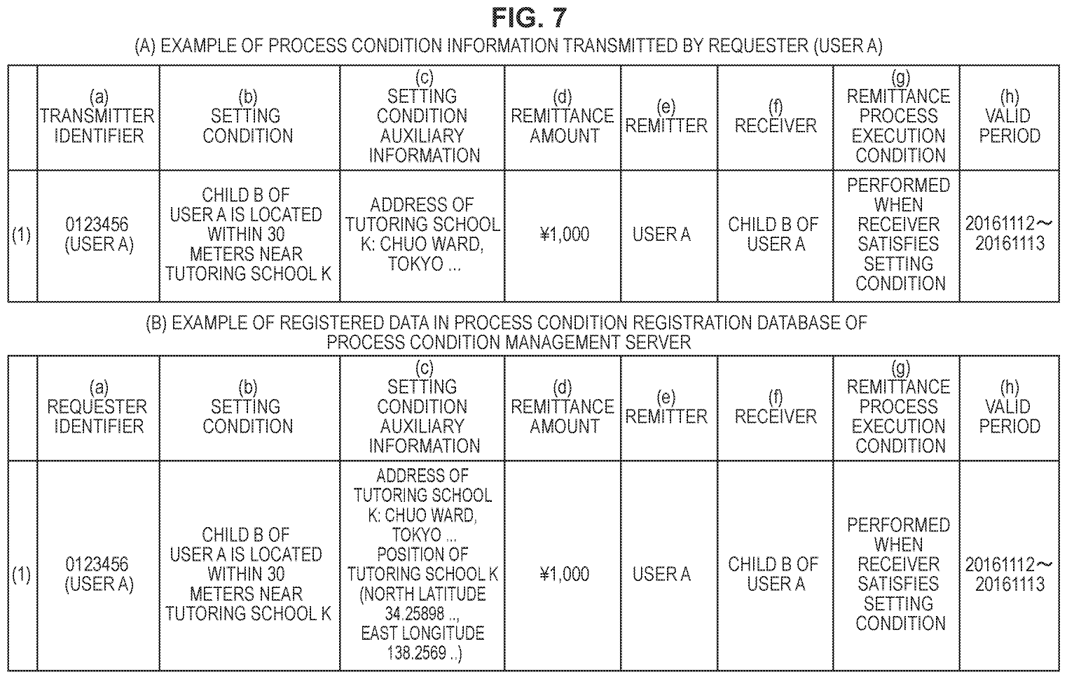

A specific example of the transmitted information is illustrated in FIG. 7(A).

As illustrated in FIG. 7(A), the process condition information transmitted from the portable terminal (A) 12 to the process condition management server 30 is, for example, data including each of the following information:

(a) transmitter identifier;

(b) setting condition;

(c) setting condition auxiliary information;

(d) remittance amount;

(e) remitter;

(f) receiver;

(g) remittance process execution condition; and

(h) valid period.

The (a) transmitter identifier is an identifier of a transmitter of the data and is the user A.

The (b) setting condition is a condition for performing a remittance process. The example illustrated in the drawing is an example in the following setting condition is set:

“the child B of the user A is located within 30 meters near a tutoring school K.”

The (c) setting condition auxiliary information is auxiliary information of the foregoing (b) setting condition, and information such as an address or the like of the tutoring school K necessary to determine whether or not the process condition management server 30 clears the conditions is recorded.

The (d) remittance amount is data indicating an amount of remittance.

The (e) remitter records a user name equivalent to the name of an account which is a remittance source. An account number of the remittance source may be recorded instead of the user name.

The (f) receiver records a user name equivalent to the name of an account of a remittance destination. An account number of the remittance destination may be recorded instead of the user name.

As the (g) remittance process execution condition, a condition for triggering start of remittance is recorded. In the example illustrated in the drawing, the following condition is recorded:

“performed when a receiver satisfies the setting condition.”

That is, the (g) remittance process execution condition in this example is designation information for outputting a remittance request to the process execution server 40 in a case in which the (b) setting condition, “the child B of the user A is located within 30 meters near a tutoring school K” is satisfied.

As the (h) valid period, a valid period which is a period in which control in accordance with the process condition information is performed is recorded.

The process condition information transmitted from the portable terminal (A) 12 to the process condition management server 30 is data that includes, for example, each of the pieces of information.

In step S103 of the sequence diagram illustrated in FIG. 6, the user A (parent) 10 inputs the process condition information to the portable terminal (A) 12 to transmit the process condition information to the process condition management server 30.

### (Step S104)

Subsequently, the process condition management server 30 registers the process condition information received from the portable terminal (A) 12 of the user A (parent) 10 in the process condition registration database. That is, a registration process on the process condition registration database 31 illustrated in FIG. 2 is performed.

A specific example of the database registration information is illustrated in FIG. 7(B).

As illustrated in FIG. 7(B), the process condition information registered in the process condition registration database 31 of the process condition management server 30 is, for example, data including each of the following information:

(a) transmitter identifier;

(b) setting condition;

(c) setting condition auxiliary information;

(d) remittance amount;

(e) remitter;

(f) receiver;

(g) remittance process execution condition; and

(h) valid period.

The information corresponds to data received from the portable terminal (A) 12 of the user A (parent) 10 illustrated in FIG. 7(A) described above.

However, partially, a process of rewriting or adding information or the like is performed to efficiently perform a condition determination process in the process condition management server 30.

For example, as the (c) setting condition auxiliary information, latitude and longitude information indicating a position corresponding to an address is recorded. This is because, for example, positional information of the user B (child) 20 received from the portable terminal (B) 22 of the user B (child) 20 is GPS information including latitude and longitude information and a condition determination process to which the GPS information is applied is efficiently performed.

The process condition management server 30 registers the process condition information illustrated in FIG. 7(B) in the process condition registration database 31 of the process condition management server 30.

The process condition management server 30 determines whether or not the condition registered in the process condition registration database 31 is satisfied on the basis of, for example, the positional information or the like received from the portable terminal (B) 22 of the user B (child) 20 and requests the process execution server 40 to perform the remittance process in accordance with the determination result.

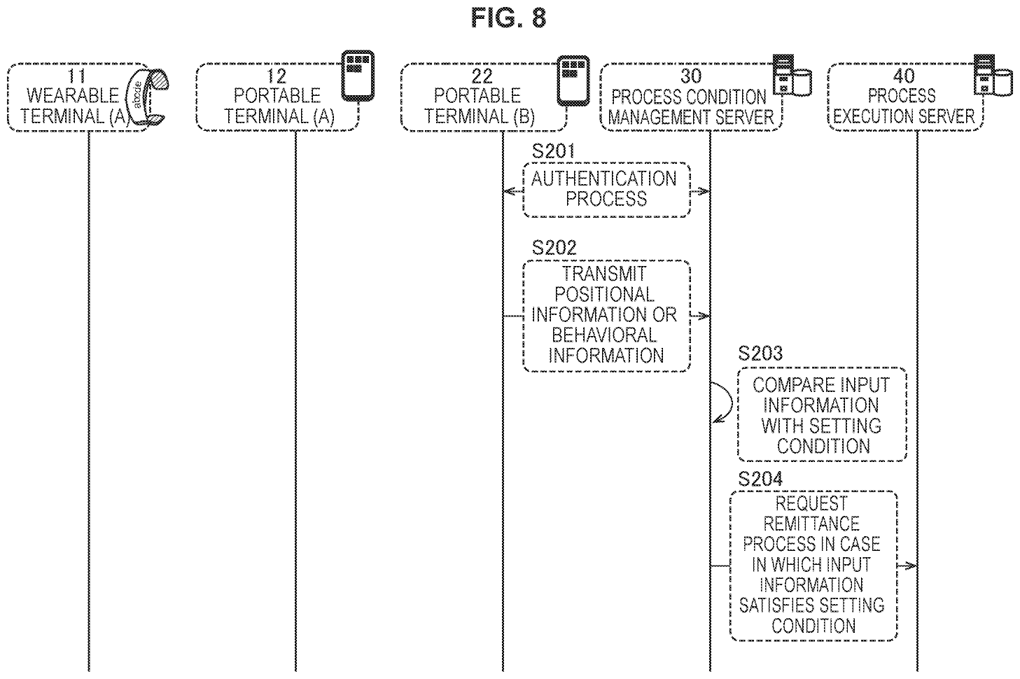

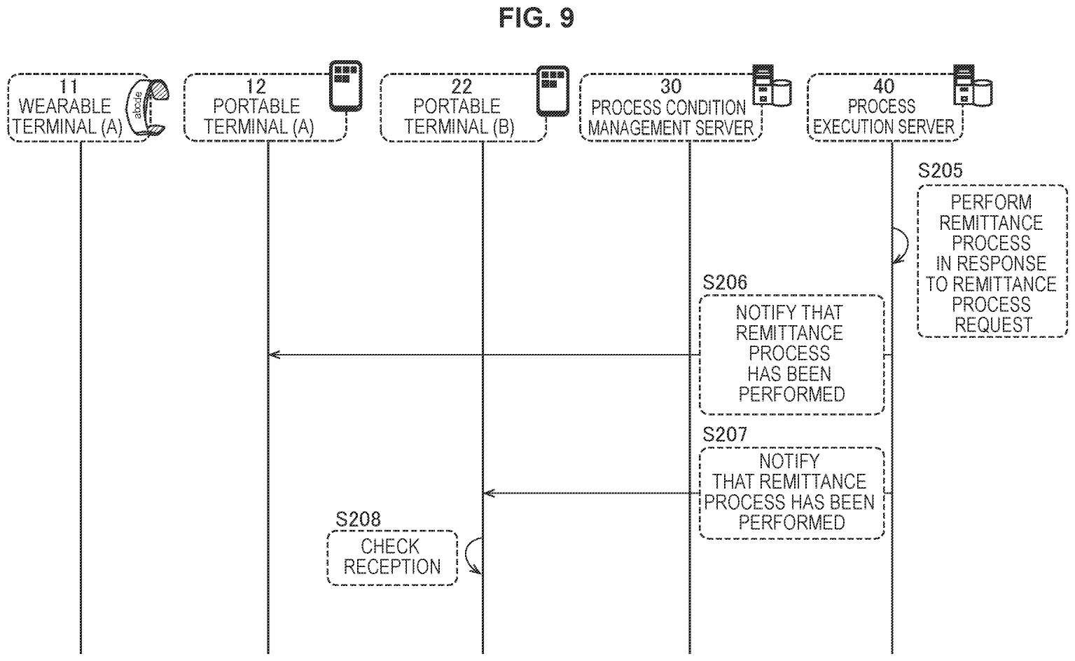

Hereinafter, a sequence of remittance executability determination and a remittance execution process based on the process condition information will be described with reference to the sequence diagrams illustrated in FIGS. 8 and 9.

The sequence diagrams of FIGS. 8 and 9 illustrate the following devices from the left, as in the sequence diagram of FIG. 6.

the wearable terminal (A) 11 of the user A (parent) 10;

the portable terminal (A) 12 of the user A (parent) 10;

the portable terminal (B) 22 of the user B (child) 20;

the process condition management server 30; and

the process execution server 40.

Hereinafter, process steps of the sequence diagram illustrated in FIG. 8 will be described in sequence.

### (Step S201)

First, an authentication process is performed between the portable terminal (B) 22 of the user B (child) 20 and the process condition management server 30.

The authentication process is an authentication process of checking reliability of both the devices and authenticating the user B (child) 20 who is the user of the portable terminal (B) 22 for user authentication.

The user authentication process is performed using authentication information which is the data retained in the process condition management server 30 and described above with reference to FIG. 3.

The portable terminal (B) 22 of the user B (child) 20 reads the biometric information of the user B (child) 20 and transmits the read biometric information to the process condition management server 30.

The process condition management server 30 performs a process of collating the biometric information received from the portable terminal (B) 22 with registration authentication information which is the data retained in the process condition management server 30 and described above with reference to FIG. 3.

When the collation is established, that is, the received data agrees with the registered data, the user of the portable terminal (B) 22 is determined to be the user B (child) 20 and the authentication is determined to be established, and then the process proceeds to a subsequent process.

Conversely, in a case in which the collation is not established, that is, the received data does not agree with the registered data, the user of the portable terminal (B) 22 is determined not to be the user B (child) 20 and the authentication is determined not to be established, and then the process is stopped without proceeding to a subsequent process. Note that, in this case, the process condition management server 30 may notify the portable terminal (B) 22 of an error message for reporting that the authentication has not been established.

Note that it is preferable to subsequently perform the authentication process of step S201 as continuous authentication periodically performed during a communication process period between the portable terminal (B) 22 and the process condition management server 30. By performing the continuous authentication, it is possible to detect changing or the like of the user during a communication execution period.

In a case in which the user is changed, the biometric authentication is not established and a subsequent process is stopped.

### (Step S202)

When the authentication process is established in step S201, the portable terminal (B) 22 of the user B (child) 20 transmits the positional information acquired by the sensor (a GPS sensor, an acceleration sensor, or the like) of the portable terminal (B) 22 or the behavioral information of the user B (child) 20 to the process condition management server 30.

The portable terminal (B) 22 includes various sensors such as a position detection sensor, an acceleration sensor, and a barometric sensor and detects a position of the portable terminal (B) 22 or a motion or the like of the portable terminal. The portable terminal (B) 22 acquires the sensor detection information and transmits the sensor detection information to the process condition management server 30.

Note that a process of transmitting the positional information or the behavioral information to the process condition management server is continuously performed. For example, the positional information or the behavioral information is intermittently transmitted at an interval (an interval of several seconds) defined in advance.

Note that, as described above, it is preferable to realize a configuration in which user authentication to which the biometric authentication information is applied is continuously performed between the portable terminal (B) 22 and the process condition management server 30 even during the data transmission process period.

Note that, as described above with reference to FIG. 3, for example, a configuration in which biometric authentication information (for example, blood vessel information or the like) acquired in advance may be stored in the storage unit of the portable terminal (B) 22, the portable terminal (B) 22 performs an authentication process of collating biometric information newly acquired from the user with the biometric information stored in the storage unit, and only an authentication result, that is, an authentication result of authentication establishment or authentication non-establishment, is transmitted to the process condition management server 30.

By performing such setting, for example, it is possible to efficiently perform the “continuous authentication process” performed periodically in a short time and it is possible to reduce an amount of communication data with the server.

### (Step S203)

Subsequently, in step S203, the process condition management server 30 compares the positional information received from the portable terminal (B) 22 or the behavioral information of the user B (child) 20 with setting condition registered in the process condition registration database 31 of the process condition management server 30.

The setting condition registered in the process condition registration database 31 of the process condition management server 30 is, for example, the “(b) setting condition” described above with reference to FIG. 7(B).

In a case in which the position or the behavior of the user (b) determined on the basis of the positional information received from the portable terminal (B) 22 or the behavioral information of the user B (child) 20 agrees with the registered setting condition, the process proceeds to step S204.

In a case in which the position or the behavior does not agree with the setting condition, reception of new information from the portable terminal (B) 22 stands by and the process of step S203 is repeated.

This process is repeatedly performed during a valid period registered in the establishment of the process condition registration database 31 of the process condition management server 30.

### (Step S204)

In a case in which the position or the behavior of the user (b) determined on the basis of the positional information received by the process condition management server 30 from the portable terminal (B) 22 or the behavioral information of the user B (child) 20 agrees with the registered setting condition, the process proceeds to step S204.

In step S204, the process condition management server 30 checks the remittance process execution condition recorded in the process condition information. In a case in which the remittance process execution condition is satisfied, the process condition management server 30 requests the remittance process from the process execution server 40.

Note that the process condition management server 30 generates remittance request data including the information of each of the remittance amount, the remitter, and the receiver and transmits the remittance request data to the process execution server 40.

Note that the data of each of the remittance amount, the remitter, and the receiver is data registered in the process condition registration database 31 of the process condition management server 30.

### (Step S205)

Subsequently, in step S205 illustrated in FIG. 9, the process execution server 40 receiving the transmission request from the process condition management server 30 performs the remittance process in response to the request.

For example, in a case in which a process in accordance with the information registered in the process condition registration database described with reference to FIG. 7(B) is performed, the remittance process in accordance with the following setting is performed:

a remittance amount=¥1,000;

a remitter=user A; and

a receiver=user B.

### (Steps S206 and S207)

Subsequently, in steps S206 and S207, the process execution server 40 performs a process of notifying the portable terminal (A) 12 and the portable terminal (B) 22 that the remittance process has been completed.

Note that the notification process may be performed on the condition that the authentication process is performed again between the communication devices and authentication establishment is checked.

### (Step S208)

Subsequently, in step S208, the portable terminal (B) 22 checks that the remittance process is performed with reference to reception information or balance information of the account of the user B (child) 20.

In this way, the process condition management server 30 determines whether or not the position or the behavior of the user B (child) 20 agrees with a setting condition registered in advance by the user A (parent) 10. In a case in which the position or the behavior agrees with the setting condition, the process execution server 40 performs the remittance process in accordance with setting defined in advance.

Note that the setting conditions of the remittance process or process conditions such as the remittance amount, the remitter, and the receiver can be variously set.

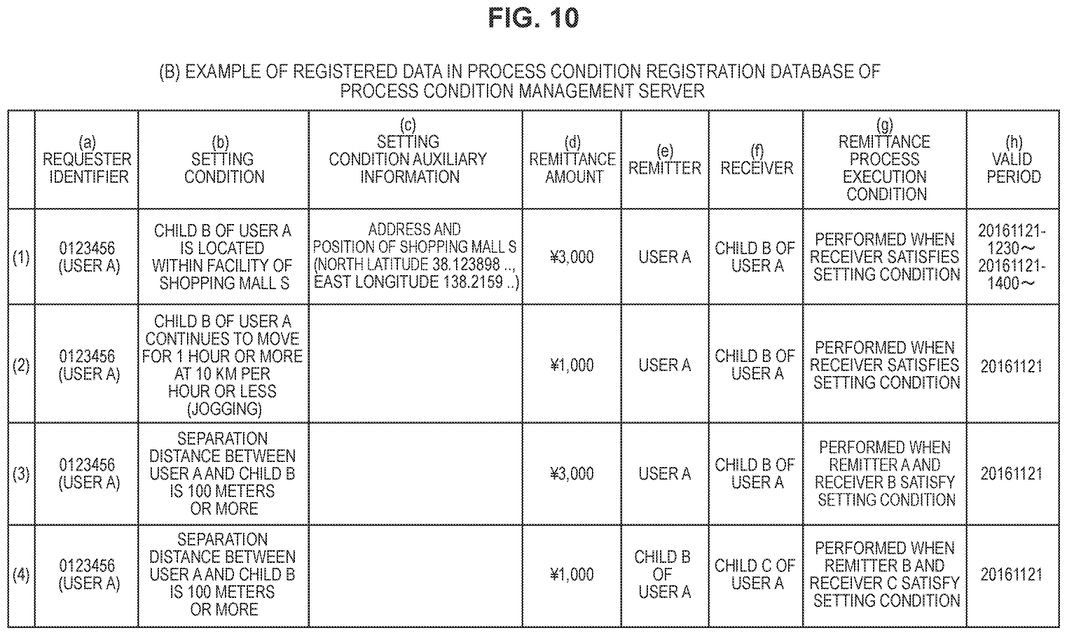

FIG. 10 illustrates example of a plurality of process conditions registered in the process condition registration database 31 of the process condition management server.

As illustrated in FIG. 10, for example, the following conditions can be defined as the “(b) setting condition” and the “(g) remittance process execution condition” in the process conditions.

(1) A setting condition=the child B of the user A is located within the facility of a shopping mall S.

A remittance process execution condition=performed when the receiver satisfies the setting condition.

(2) A setting condition=the child B of the user A continues to move for 1 hour or more at 10 km or less per hour (jogging).

A remittance process execution condition=performed when the receiver satisfies the setting condition.

(3) A setting condition=a separation distance between the user A and the child B is 100 meters or more.

A remittance process execution condition=performed when the remitter A and the receiver B satisfy the setting condition.

(4) A setting condition=a separation distance between the user A and the child B is 100 meters or more.

A remittance process execution condition=performed when the remitter B and the receiver C satisfy the setting condition.

In this way, the setting condition, the remittance process execution condition, the remitter, the receiver, the remittance amount, and the like can be variously set.

Note that there are various users who are acquisition targets of the positional information or the behavioral information set as the setting condition, and the process management server 30 selects a user who is an acquisition target of the positional information or the behavioral information in accordance with a condition included in the setting condition and performs a process of acquiring information (position/behavior) from a portable terminal or the like of the selected user.

For example, in the example illustrated in FIG. 10(3), the setting condition is the following condition:

a setting condition=a separation distance between the user A and the child B is 100 meters or more.

In a process of determining whether or not this condition is satisfied, it is necessary to acquire positional information of the user A and the user B.

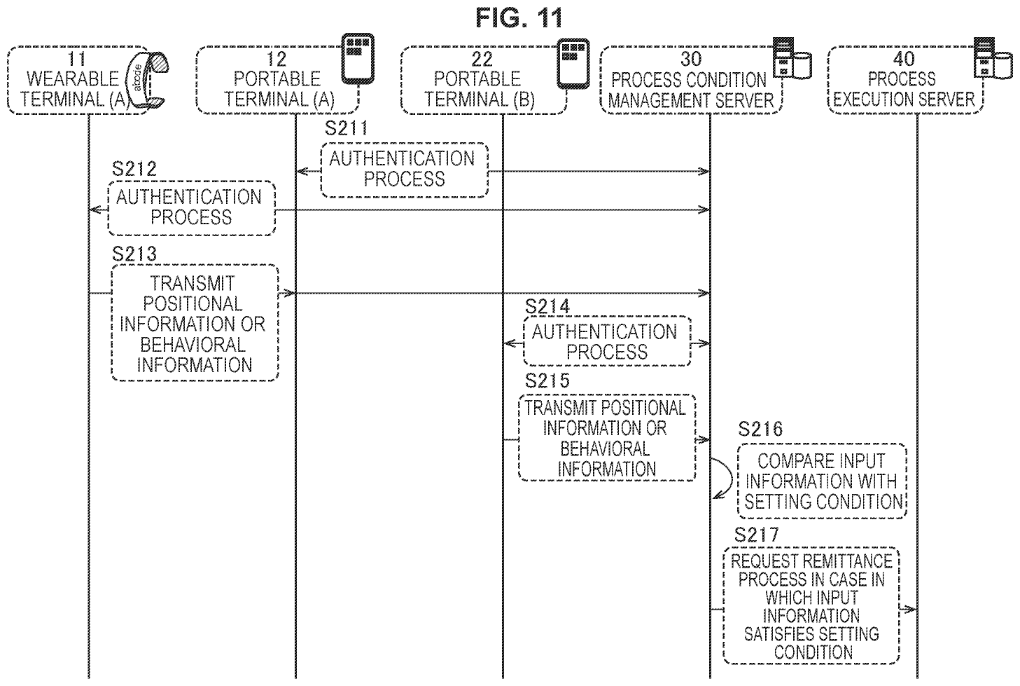

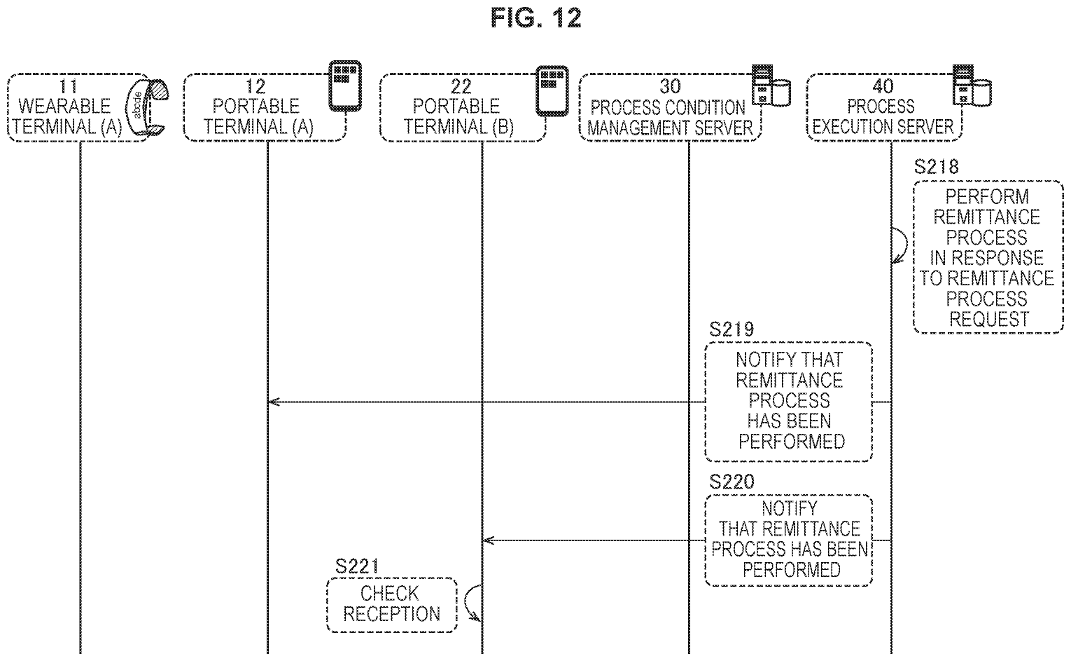

A process sequence of such a case will be described with reference to FIGS. 11 and 12.

The sequence diagrams of FIGS. 11 and 12 also illustrate the following devices from the left, as in the sequence diagrams of FIGS. 8 and 9.

the wearable terminal (A) 11 of the user A (parent) 10;

the portable terminal (A) 12 of the user A (parent) 10;

the portable terminal (B) 22 of the user B (child) 20;

the process condition management server 30; and

the process execution server 40.

Hereinafter, process steps of the sequence diagram illustrated in FIG. 11 will be described in sequence.

### (Steps S211 and S212)

In the example of the process, to acquire the positional or behavioral information of the user A (parent) 10 from the wearable terminal (A) 11 or the portable terminal (A) 12 of the user A (parent) 10, an authentication process is performed between each terminal and the process condition management server 30.

The user authentication process is performed using authentication information which is the data retained in the process condition management server 30 and described above with reference to FIG. 3.

Each terminal of the user A (parent) 10 reads the biometric information of the user A (parent) 10 and transmits the read biometric information to the process condition management server 30.

The process condition management server 30 performs a process of collating the biometric information received from each terminal with registration authentication information which is the data retained in the process condition management server 30 and described above with reference to FIG. 3.

When the collation is established, that is, the received data agrees with the registered data, the user of each terminal is determined to be the user A (parent) 10 and the authentication is determined to be established, and then the process proceeds to a subsequent process.

In the case of the collation non-establishment, the authentication is determined not to be established and the process is stopped.

### (Step S213)

When the authentication process in steps S211 and S212 is established, the wearable terminal (A) 11 or the portable terminal (A) 12 of the user A (parent) 10 transmits the positional information acquired by the sensor (the GPS sensor, the acceleration sensor, or the like) of each terminal or the behavioral information of the user A (parent) 10 to the process condition management server 30.

The wearable terminal (A) 11 and the portable terminal (A) 12 include various sensors such as a position detection sensor, an acceleration sensor, and a barometric sensor to detect a position, a motion, and the like. The wearable terminal (A) 11 and the portable terminal (A) 12 acquire the information detected by these sensors and transmit the acquired information or positional information or behavioral information generated on the basis of the acquired information to the process condition management server 30.

Note that, as described above, it is preferable to realize a configuration in which the user authentication to which the biometric authentication information is applied is continuously performed between the wearable terminal (A) 11 and the portable terminal (A) 12, and the process condition management server 30 during a period of the data transmission process.

### (Steps S214 to 221)

The followings processes of steps S214 to S221 are processes similar to the processes of steps S201 to S208 described above with reference to FIGS. 8 and 9.

Here, in a process of comparing the input information with the registration setting condition in step S216 by the process condition management server 30, a determination process based on the position or the behavior of the following two users is performed:

positional or behavioral information of the user A (parent) 10 received from the wearable terminal (A) 11 or the portable terminal (A) 12 of the user A (parent) 10; and

positional or behavioral information of the user B (child) 20 received from the portable terminal (B) 22 of the user B (child) 20.

The process condition management server 30 performs a process of determining whether or not the registered setting condition, that is, the following condition, is satisfied on the basis of the positional information or the behavioral information of the two users A and B:

“setting condition=a separation distance between the user A and the child B is 100 meters or more.”

Further, the process condition management server 30 outputs a request for the remittance process in step S217 to the process execution server 40 in a case in which satisfaction of the process execution condition is checked:

“process execution condition=performed when the remitter A and the receiver B satisfy the setting condition.”

In this way, the process condition management server 30 selects an acquisition destination of the positional or behavioral information in accordance with the process conditions registered in the database, collects the information, and determines whether or not the setting condition is satisfied.

Note that, in the above-described embodiment, only the setting in which the remittance process is performed in the case in which the setting conditions are all satisfied has been described. However, for example, a condition that a refunding process (penalty) is performed in a case in which the setting conditions are not satisfied can also be set.

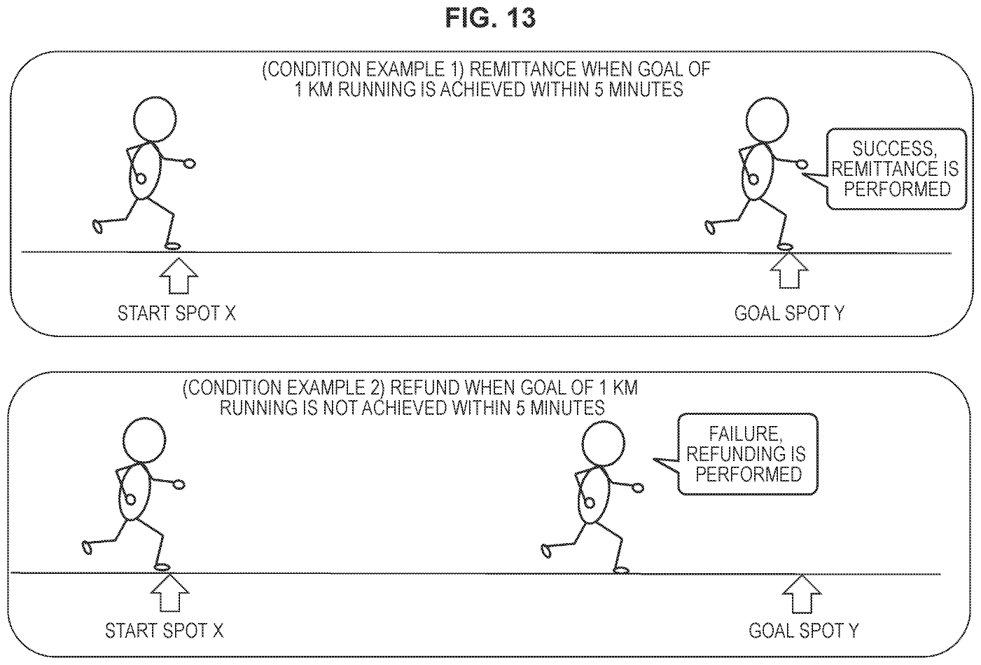

A process example based on such condition setting will be described with reference to FIG. 13.

FIG. 13 illustrates the following two condition examples:

(condition example 1) remittance when a goal of 1 Km running is achieved within 5 minutes; and

(condition example 2) refund when the goal of 1 Km running is not achieved within 5 minutes.

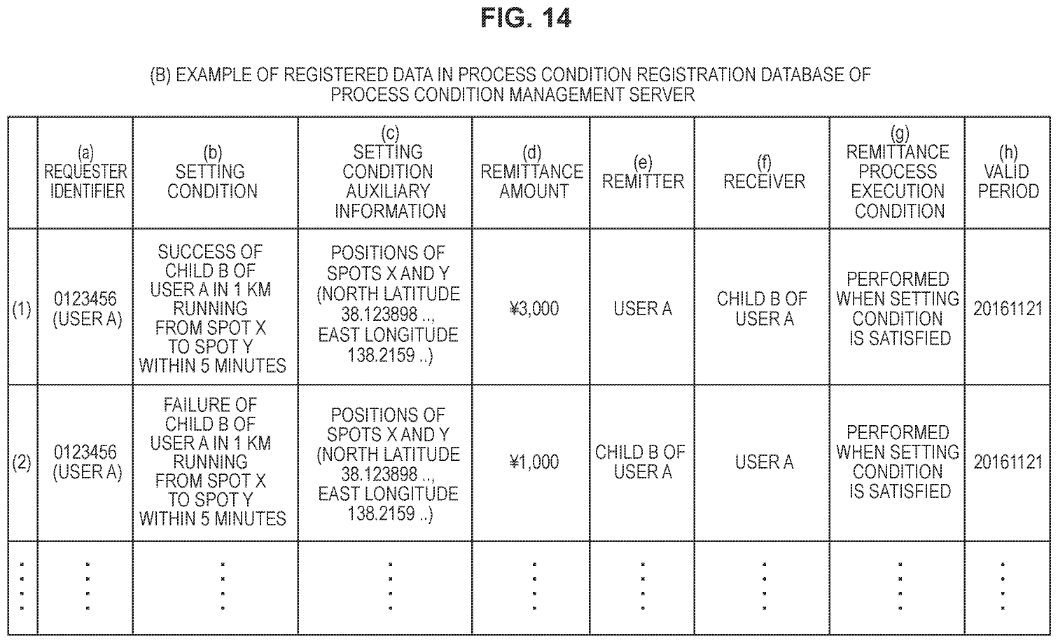

FIG. 14 illustrates a register data example of the process condition registration database of the process condition management server 30 corresponding to the two conditions. A data entry (1) illustrated in FIG. 14 is registered data corresponding to (condition example 1) of FIG. 13 and a data entry (2) is registered data corresponding to (condition example 2) of FIG. 13.

The “(b) setting condition,” the “(g) remittance process execution condition,” the “(e) remitter,” and the “(f) receiver” of each piece of registered data are as follows.

(1) A setting condition=success of the child B of the user A in the 1 Km running from a spot X to a spot Y within 5 minutes.

A remittance process execution condition=performed when the receiver satisfies the setting condition.

A remitter=the user A; and

A receiver=the user B who is the child of the user A.

(2) A setting condition=failure of the child B of the user A in the 1 Km running from the spot X to the spot Y within 5 minutes.

A remittance process execution condition=performed when the receiver satisfies the setting condition.

A remitter=the user B who is the child of the user A; and

A receiver=the user A.

In this way, in (1) and (2), the setting conditions are the success and the failure which are reverse setting and the setting of the remitter and the receiver is changed.

In the case of (1), the remitter=the user A (parent) and the receiver=the user B (child). When the goal succeeds within the time, a remittance process is performed from the user A (parent) to the user B (child).

On the other hand, in the case of (2), the remitter=the user B (child) and the receiver=the user A (parent). When the goal is not achieved within the time, a remittance process is performed from the user B (child) to the user A (parent). That is, the remittance (=refunding) process from the child to the parent is performed.

In this way, various processes can be performed by changing the setting aspects of the process conditions.

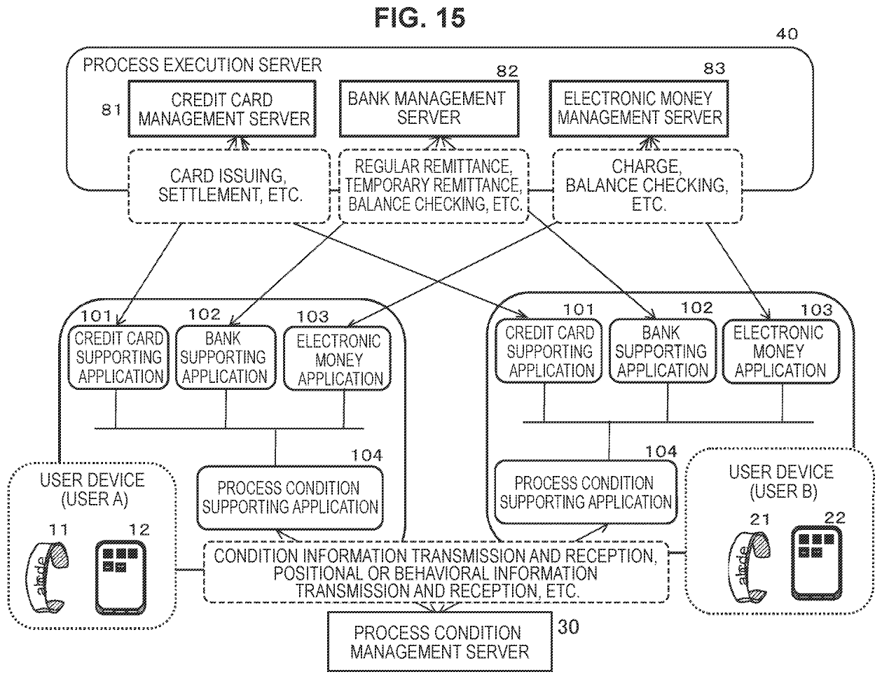

FIG. 15 is an explanatory diagram illustrating an example of an application performed in the devices (terminals) held or worn by the users and a specific example of the process execution server 40.

In FIG. 15, the wearable terminal (A) 11 and the portable terminal (A) 12 are illustrated as the devices (terminals) held or worn by the user A (parent) 10. In addition, the wearable terminal (B) 21 and the portable terminal (B) 22 are illustrated as the devices (terminals) held or worn by the user B (child) 20.

In addition, as examples of the process execution server 40, a credit card management server 81, a bank management server 82, and an electronic money management server 83 are illustrated.

These servers are examples of the server that performs the remittance process.

In the devices (terminals) of each user, a credit card supporting application 101, a bank supporting application 102, an electronic money application 103, a process condition supporting application 104, and the like are performed in a data processing unit.

The process condition supporting application 104 is an application that performs various processes performed in a communication process with the process condition management server, for example, processes such as an authentication process, a process condition registration process, a transmission process for positional information or behavioral information, and the like.

The credit card supporting application 101 is used when a remittance process, a reception process, and a balance checking process using accounts registered in a credit card company and further various processes such as card issuing and a settlement process using a card are performed.

The bank supporting application 102 is used when a remittance process, a reception process, a balance checking process, and the like using accounts of banks are performed.

The electronic money application 103 is used when a remittance process, a reception process, a balance checking process, and the like using electronic money accounts are performed.

Note that electronic money accounts are associated with specific bank accounts in many cases, and thus upper limit amounts of money set in advance are configured to be movable from the bank accounts to the electronic money accounts.

Each user terminal can perform the processes according to the above-described embodiment using, for example, each application illustrated in FIG. 15.

### 3. Embodiment in which Remittance Control of Service Price Payment is Performed in Accordance with Position or Behavior of User

Next, an embodiment in which remittance control of service price payment is performed in accordance with a position or a behavior of a user will be described.

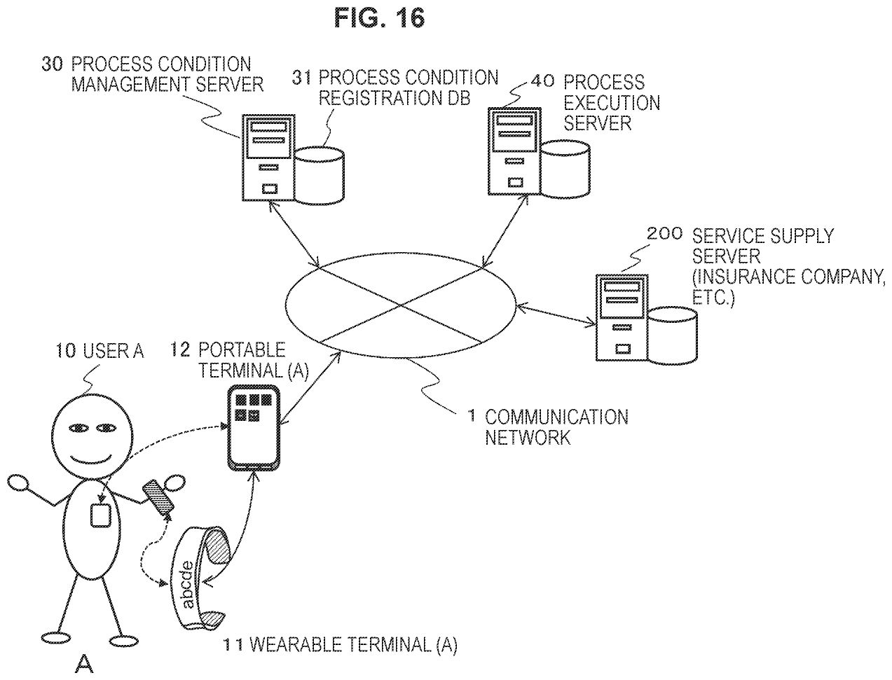

A configuration example of the information processing system realizing the embodiment will be described with reference to FIG. 16.

FIG. 16 illustrates a user A 10.

The user A 10 mounts the wearable terminal (A) 11 on his or her arm and keeps the portable terminal (A) 12 in his or her chest pocket.

Both the wearable terminal (A) 11 and the portable terminal (A) 12 are an information processing device that has an electronic money function, further includes a sensor that detects positional information or motion information, and further includes a data processing unit, a display unit, and a communication unit that perform various applications and data processing.

The wearable terminal (A) 11 and the portable terminal (A) 12 each have a configuration for performing mutual communication. For example, the wearable terminal (A) 11 and the portable terminal (A) 12 perform data communication in conformity with the Blutooth (registered trademark) low energy (BLE) standard which is a low power consumption type Bluetooth (registered trademark) (BT: Bluetooth (registered trademark)) communication.

The portable terminal (A) 12 further has a configuration capable of performing communication with various communication devices, for example, a server connected to a network 1 or other user terminals, via the network 1 such as the Internet through Wi-Fi communication.

The process condition management server 30, the process execution server 40, and further the service supply server (an insurance company or the like) 200 are connected to the network 1.

For example, the process condition management server 30 stores condition data (setting condition) which is allowable condition information for performing a remittance process from an amount (a bank account, an electronic money account, or the like) of the user A 10 to an account (a bank account, an electronic money account or the like) of a management company of the service supply server 200 in a storage unit (database). Further, a process of determining whether or not the setting condition retained in the storage unit is satisfied is performed.

The setting condition is a condition set on the basis of content contracted in advance between the management company of the service supply server 200 and the user A 10.

The process condition management server 30 is notified of the process condition information such as the setting condition by the service supply server 200.

The process condition management server 30 stores the process condition information including information regarding a remittance amount, a remitter, a receiver, and the like in addition to the setting condition in the process condition registration database 31.

The process condition management server 30 compares the positional information or the behavioral information of the user A 10 transmitted from the wearable terminal (A) 11 or the portable terminal (A) 12 of the user A 10 with the process condition stored in the process condition registration database 31, and requests the process execution server 40 to perform the remittance process in a case in which the registered conditions are determined to be satisfied.

The process execution server 40 is, for example, a server that is managed by a bank and performs a remittance process from the account of the user A 10 to the account of the management company of the service supply server 200 in response to reception of the request for the remittance process from the process condition management server 30.

Note that in the embodiment to be described below, the service supply server 200 is used as an example, and an example in which the service supply server 200 is a server of the insurance company (the service supply company) and a fare is paid on the basis of an insurance contract made with the user A 10 by the insurance company will be described.

The service supply server 200 is not limited to the insurance company and can be administrated by a company that supplies other various services, and the embodiment to be described below can be applied to a fare payment system in accordance with various services.

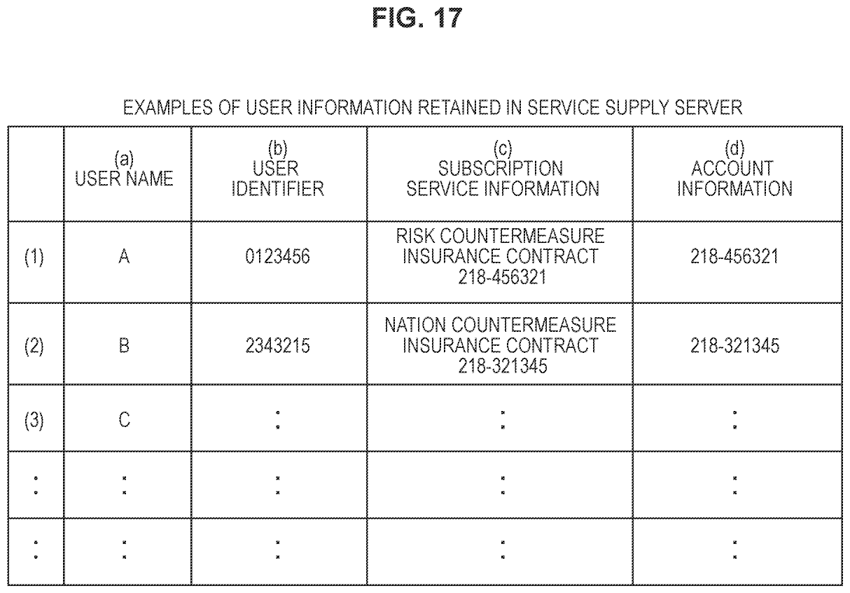

FIG. 17 illustrates an example of user information stored in the storage unit of the service supply server 200 by the insurance company on the basis of the content contracted in advance between the management company which is an insurance company (the service supply company) of the service supply server 200 and the user A 10.

As illustrated in FIG. 17, the following information is stored as correspondent data in the service supply server 200 of the insurance company (the service supply company):

(a) user name;

(b) user identifier;

(c) subscription service information; and

(d) account information.

The (a) user name is the name of a user who receives a service (insurance).

As the (b) user identifier, an identifier (ID) specific to the user is recorded.

The (c) subscription service information is a contract target service and is insurance contract information in this example.

The (d) account information is account information of the user for price payment occurring in a case in which the service (insurance) supplied by the service supply company (the insurance company in this example) is supplied to the user.

For example, this information is stored in the service supply server 200.

Note that the process condition management server 30 and the process execution server 40 illustrated in FIG. 16 each register the user information and store the user information in the storage unit.

This user information is information similar to the information described above in the embodiment.

That is, the process condition management server 30 retains the user information described above with reference to FIG. 3, that is, correspondent information of each of the following data as the user information in the storage unit:

(a) terminal identifier;

(b) user name;

(c) user identifier (ID);

(d) user authentication information; and

(e) user relation information.

In addition, the process execution server 40 retains the user information described above with reference to FIG. 4, that is, correspondent information of each of the following data as the user information in the storage unit:

(a) terminal identifier;

(b) user name;

(c) user identifier (ID);

(d) account information; and

(e) user authentication information.

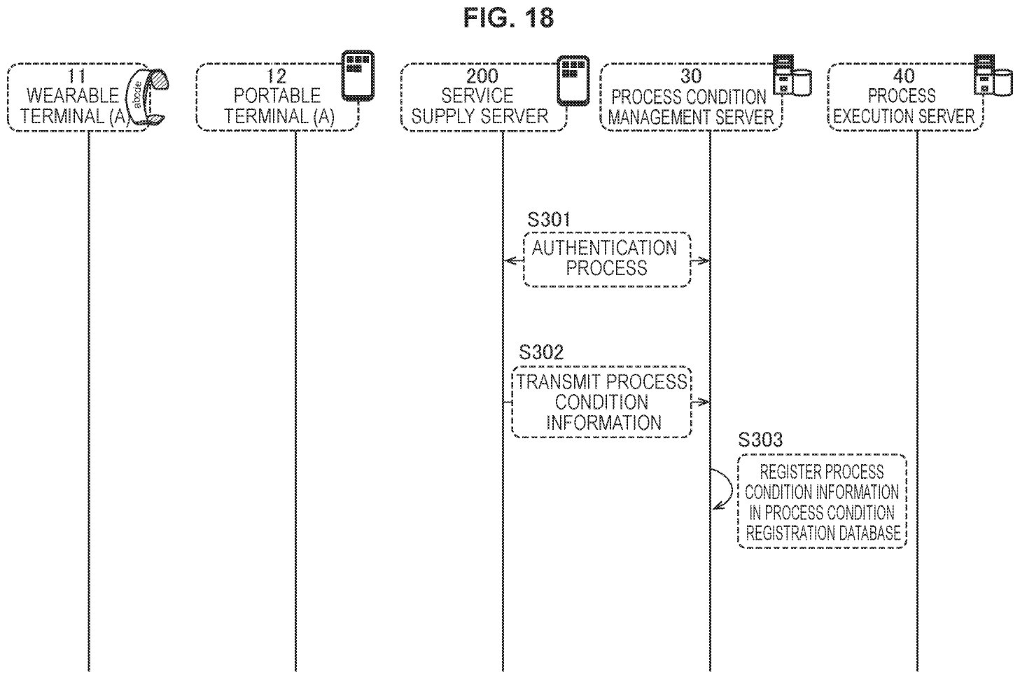

Next, a process sequence of a process of registering remittance process conditions in the process condition management server 30 by the service supply server 200 will be described with reference to the sequence diagram illustrated in FIG. 18.

FIG. 18 illustrates each of the following devices from the left:

the wearable terminal (A) 11 of the user A 10;

the portable terminal (A) 12 of the user A 10;

the service supply server 200;

the process condition management server 30; and

the process execution server 40.

Hereinafter, process steps of the sequence diagram illustrated in FIG. 18 will be described in sequence.

### (Step S301)

First, an authentication process is performed between the service supply server 200 and the process condition management server 30.

The authentication process is performed as a process of checking reliability of both the devices.

In the case of the authentication establishment, the process proceeds to a subsequent process.

Conversely, in the case of the authentication non-establishment, the following process is stopped.

### (Step S302)

When the authentication process of step S301 is established, the service supply server 200 subsequently transmits process condition information generated on the basis of the contract made in advance with the user A 10 to the process condition management server 30 in step S302.

That is, the process condition information including a remittance amount, a remitter, a receiver, and the like or the setting condition in a case in which the remittance process is performed from the account of the service supply server 200 is transmitted to the process condition management server 30.

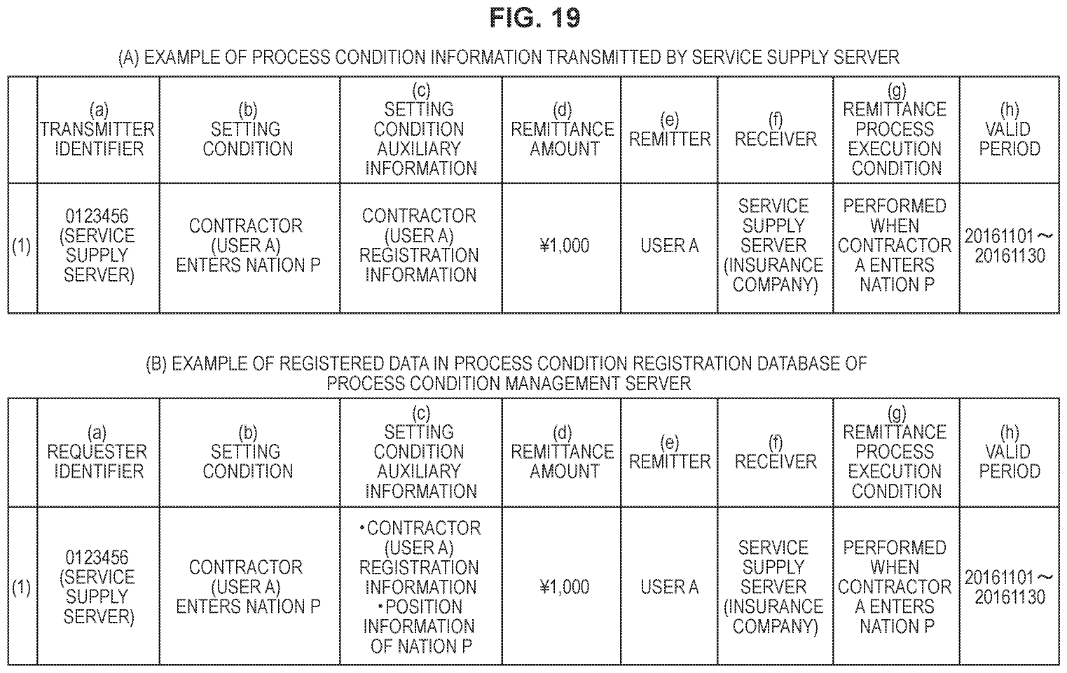

A specific example of the transmitted information is illustrated in FIG. 19(A).

As illustrated in FIG. 19(A), the process condition information transmitted from the service supply server 200 to the process condition management server 30 is, for example, data including each of the following information:

(a) transmitter identifier;

(b) setting condition;

(c) setting condition auxiliary information;

(d) remittance amount;

(e) remitter;

(f) receiver;

(g) remittance process execution condition; and

(h) valid period.

The (a) transmitter identifier is an identifier of a transmitter of the data and is the service supply server 200.

The (b) setting condition is a condition for performing a remittance process.

The example illustrated in the drawing is an example in the following setting condition is set:

“the contractor (user A) enters Nation P.”

The (c) setting condition auxiliary information is auxiliary information of the foregoing (b) setting condition. For example, information such as registration information of the contractor (the user A) necessary to determine whether or not the process condition management server 30 clears the conditions, information is recorded.

The (d) remittance amount is data indicating an amount of remittance.

The (e) remitter records a user name equivalent to the name of an account which is a remittance source. An account number of the remittance source may be recorded instead of the user name.

The (f) receiver records a user name equivalent to the name of an account of a remittance destination. In this example, an account name of the insurance company is recorded. Instead of the account name, an account number may be recorded.

As the (g) remittance process execution condition, a condition for triggering start of remittance is recorded. In the example illustrated in the drawing, the following condition is recorded:

“performed when the contractor A enters Nation P.”

That is, the (g) remittance process execution condition in this example is designation information for outputting a remittance request to the process execution server 40 in a case in which the (b) setting condition, “the contractor (user A) enters Nation P,” satisfies the setting condition.

As the (h) valid period, a valid period which is a period in which control in accordance with the process condition information is performed is recorded.

The process condition information transmitted from the service supply server 200 to the process condition management server 30 is, for example, data including the information.

In step S302 illustrated in FIG. 18, the service supply server 200 transmits the process condition information to the process condition management server 30.

### (Step S303)

Next, the process condition management server 30 registers the process condition information received from the service supply server 200 in the process condition registration database in step S303. That is, a registration process on the process condition registration database 31 illustrated in FIG. 16 is performed.

A specific example of the database registration information is illustrated in FIG. 19(B).

As illustrated in FIG. 19(B), the process condition information registered in the process condition registration database 31 of the process condition management server 30 is, for example, data including each of the following information:

(a) transmitter identifier;

(b) setting condition;

(c) setting condition auxiliary information;

(d) remittance amount;

(e) remitter;

(f) receiver;

(g) remittance process execution condition; and

(h) valid period.

The information corresponds to data received from the service supply server 200 illustrated in FIG. 19(A) described above.

However, partially, a process of rewriting or adding information or the like is performed to efficiently perform a condition determination process in the process condition management server 30.

For example, as the (c) setting condition auxiliary information, latitude and longitude information indicating a position of Nation P is recorded. This is because, for example, positional information received from the portable terminal (A) 12 of the user A 10 is GPS information including latitude and longitude information and a condition determination process to which the GPS information is applied is efficiently performed.

The process condition management server 30 registers the process condition information illustrated in FIG. 19(B) in the process condition registration database 31 of the process condition management server 30.

The process condition management server 30 determines whether or not the condition registered in the process condition registration database 31 is satisfied on the basis of, for example, the positional information or the like received from the portable terminal (B) 12 of the user A 10 and requests the process execution server 40 to perform the remittance process in accordance with the determination result.

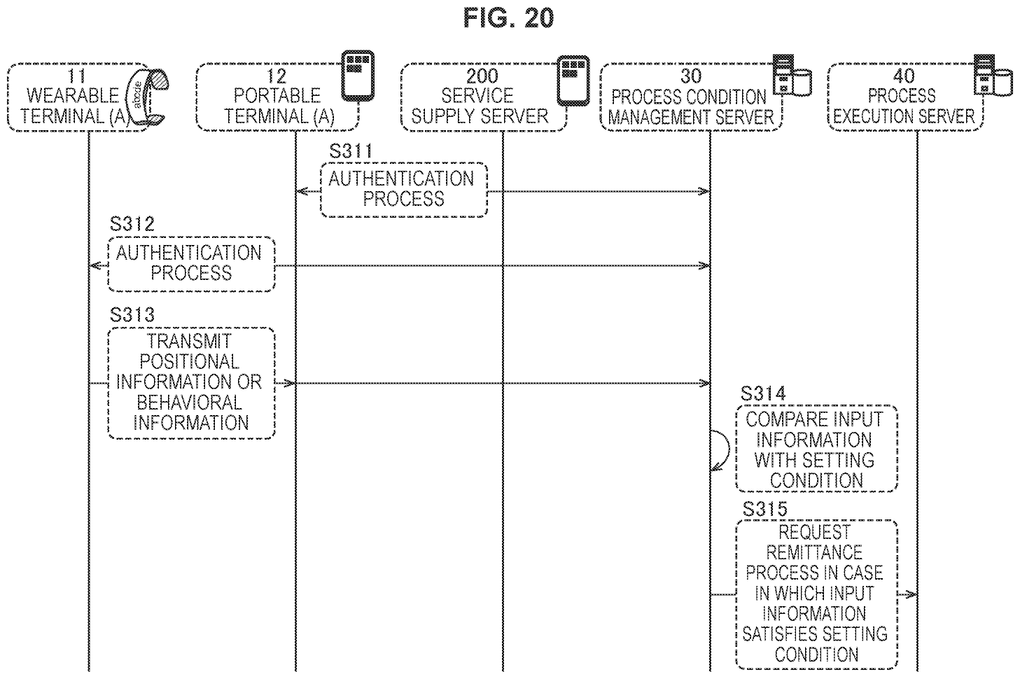

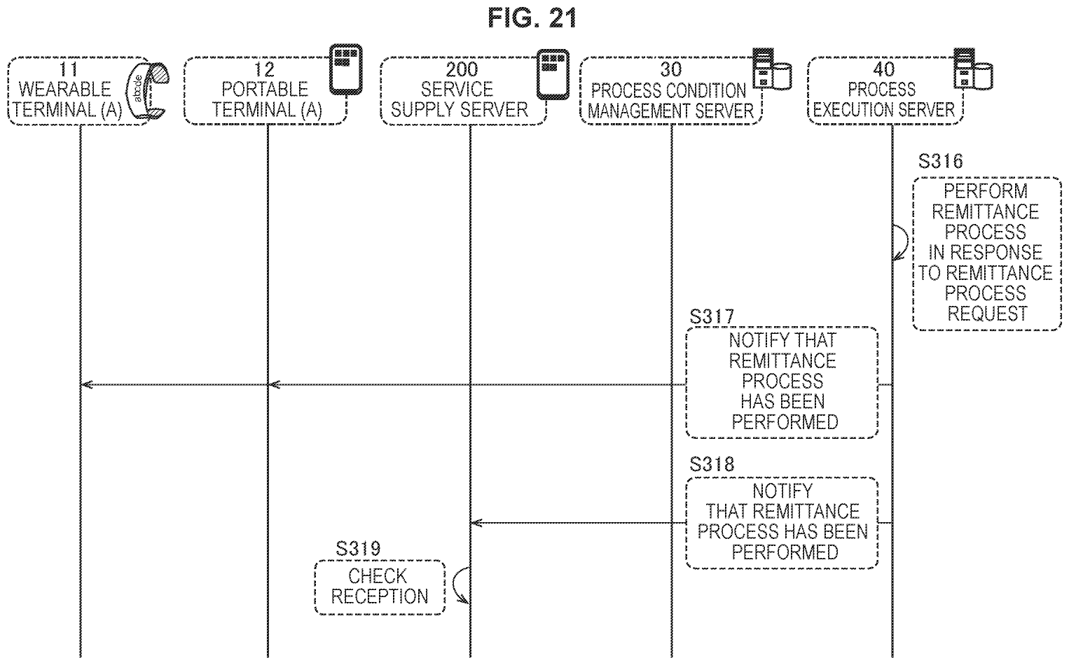

Hereinafter, a sequence of remittance executability determination and a remittance execution process based on the process condition information will be described with reference to the sequence diagrams illustrated in FIGS. 20 and 21.

The sequence diagrams of FIGS. 20 and 21 illustrate the following devices from the left, as in the sequence diagram of FIG. 18 described above.

the wearable terminal (A) 11 of the user A 10;

the portable terminal (A) 12 of the user A 10;

the service supply server 200;

the process condition management server 30; and

the process execution server 40.

Hereinafter, process steps of the sequence diagrams illustrated in FIGS. 20 and 21 will be described in sequence.

### (Step S311)

First, an authentication process is performed between the portable terminal (A) 12 of the user A 10 and the process condition management server 30.

The authentication process is an authentication process of checking reliability of both the devices and authenticating the user A 10 who is the user of the wearable terminal (A) 11 for user authentication.

The user authentication process is performed using authentication information which is the data retained in the process condition management server 30 and described above with reference to FIG. 3.

The portable terminal (A) 12 of the user A 10 reads the biometric information of the user A 10 and transmits the read biometric information to the process condition management server 30.

The process condition management server 30 performs a process of collating the biometric information received from the terminal with registration authentication information which is the data retained in the process condition management server 30 and described above with reference to FIG. 3.

When the collation is established, that is, the received, data agrees with the registered data, the user of the portable terminal (A) 12 of the user A 10 is determined to be the user A 10 and the authentication is determined to be established, and then the process proceeds to a subsequent process.

In the case of the collation non-establishment, the authentication is determined not to be established and the process is stopped. In this case, an error message for reporting the authentication non-establishment may be notified of.

Note that it is preferable to subsequently perform the authentication process of step S311 as continuous authentication periodically performed during a communication process period between the portable terminal (A) 12 and the process condition management server 30. By performing the continuous authentication, it is possible to detect changing or the like of the user during a communication execution period.

In a case in which the user is changed, the biometric authentication is not established and a subsequent process is stopped.

### (Step S312)

When the authentication process in step S311 is established, an authentication process is subsequently performed between the wearable terminal (A) 11 of the user A 10 and the process condition management server 30.

Note that this process is a process necessary in a case in which data communication with the process condition management server 30 is performed using the wearable terminal (A) 11. A case in which the data communication with the process condition management server 30 is not performed using the wearable terminal (A) 11 can be omitted.

In step S312, an authentication process is performed between the wearable terminal(A) 11 of the user A 10 and the process condition management server 30.

The authentication process is an authentication process of checking reliability of both the devices and authenticating the user A 10 who is the user of the wearable terminal (A) 11 for user authentication.

This user authentication process is performed using authentication information which is the data retained in the process condition management server 30 and described above with reference to FIG. 3.

The wearable terminal (A) 11 of the user A 10 reads the biometric information of the user A 10 and transmits the read biometric information to the process condition management server 30.

The process condition management server 30 receives the biometric information read by the wearable terminal (A) 11 via the portable terminal (A) 12 for which the authentication process has already been completed and performs a process of collating the received biometric information with the registration authentication information which is the data retained in the process condition management server 30 and described above with reference to FIG. 3.

When the collation is established, that is, the received data agrees with the registered data, the user of the wearable terminal (A) 11 is determined to be the user A 10 and the authentication is determined to be established, and then the process proceeds to a subsequent process.

Conversely, when the collation is not established, that is, the received data does not agree with the registered data, the user of the wearable terminal (A) 11 is determined not to be the user A 10 and the authentication is determined not to be established, and then the process is stopped without proceeding to a subsequent process. Note that, in this case, the process condition management server 30 may notify the wearable terminal (A) 11 or the portable terminal (A) 12 of an error message for reporting that the authentication has not been established.

### (Step S313)

When the authentication process in steps S311 and S312 is established, the wearable terminal (A) 11 or the portable terminal (A) 12 of the user A 10 transmits the positional information acquired by the sensor (the GPS sensor, the acceleration sensor, or the like) of each terminal or the behavioral information of the user A (parent) 10 to the process condition management server 30.

The wearable terminal (A) 11 and the portable terminal (A) 12 include various sensors such as a position detection sensor, an acceleration sensor, and a barometric sensor to detect a position, a motion, and the like. The wearable terminal (A) 11 and the portable terminal (A) 12 acquire the information detected by the sensors and transmit the information to the process condition management server 30.

Note that a process of transmitting the positional information or the behavioral information to the process condition management server is continuously performed. For example, the positional information or the behavioral information is intermittently transmitted at an interval (an interval of several seconds) defined in advance.

Note that, as described above, it is preferable to realize a configuration in which the user authentication to which the biometric authentication information is applied is continuously performed between the wearable terminal (A) 11 and the portable terminal (A) 12, and the process condition management server 30 during a period of the data transmission process.

Note that, as described above with reference to FIG. 3, for example, a configuration in which biometric authentication information (for example, blood vessel information or the like) acquired in advance may be stored in the storage unit of the wearable terminal (A) 11 or the portable terminal (A) 12, the wearable terminal (A) 11 or the portable terminal (A) 12 performs an authentication process of collating biometric information newly acquired from the user with the biometric information stored in the storage unit, and only an authentication result, that is, an authentication result of authentication establishment or authentication non-establishment, is transmitted to the process condition management server 30.

By performing such setting, for example, it is possible to efficiently perform the “continuous authentication process” performed periodically in a short time and it is possible to reduce an amount of communication data with the server.

### (Step S314)

Subsequently, in step S314, the process condition management server 30 compares the positional information received from the wearable terminal (A) 11 or the portable terminal (A) 12 or the behavioral information of the user A 11 with setting condition registered in the process condition registration database 31 of the process condition management server 30.

The setting condition registered in the process condition registration database 31 of the process condition management server 30 is, for example, the “(b) setting condition” described above with reference to FIG. 19(B).

In a case in which the position or the behavior of the user (b) determined on the basis of the positional information received from the wearable terminal (A) 11 or the portable terminal (A) 12 or the behavioral information of the user A 11 agrees with the registered setting condition, the process proceeds to step S315.

In a case in which the position or the behavior does not agree with the setting condition, reception of new information from the wearable terminal (A) 11 or the portable terminal (A) 12 stands by and the process of step S314 is repeated.

This process is repeatedly performed during a valid period registered in the establishment of the process condition registration database 31 of the process condition management server 30.

### (Step S315)

In a case in which the position or the behavior of the user (b) determined on the basis of the positional information received by the process condition management server 30 from the wearable terminal (A) 11 or the portable terminal (A) 12 or the behavioral information of the user A 11 agrees with the registered setting condition, the process proceeds to step S315.

In step S315, the process condition management server 30 checks the remittance process execution condition recorded in the process condition information. In a case in which the remittance process execution condition is satisfied, the process condition management server 30 requests the remittance process from the process execution server 40.

Note that the process condition management server 30 generates remittance request data including the information of each of the remittance amount, the remitter, and the receiver and transmits the remittance request data to the process execution server 40.

Note that the data of each of the remittance amount, the remitter, and the receiver is data registered in the process condition registration database 31 of the process condition management server 30.

### (Step S316)

Subsequently, in step S316 illustrated in FIG. 21, the process execution server 40 receiving the transmission request from the process condition management server 30 performs the remittance process in response to the request.

For example, in a case in which a process in accordance with the information registered in the process condition registration database described with reference to FIG. 19(B) is performed, the remittance process in accordance with the following setting is performed:

a remittance amount=¥1,000;

a remitter=user A; and

a receiver=regular Service server (insurance company).

### (Steps S317 and S318)

Subsequently, in steps S317 and S318, the process execution server 40 performs a process of notifying the portable terminal (A) 12 and the wearable terminal (A) 11 of the user A11 and further the service supply server 200 that the remittance process has been completed.

Note that the notification process may be performed on the condition that the authentication process is performed again between the communication devices and authentication establishment is checked.

### (Step S319)

Subsequently, in step S319, the service supply server 200 checks the account of the service supply server 200 and checks that the remittance process from the user A11 is performed.

In this way, the service supply server 200 determines whether or not the position or the behavior of the user A11 agrees with a setting condition registered in advance on the basis of the contract with the user A11. In a case in which the position or the behavior agrees with the setting condition, the process execution server 40 performs the remittance process in accordance with setting defined in advance.

Note that the setting conditions of the remittance process or process conditions such as the remittance amount, the remitter, and the receiver can also be variously set in the embodiment.

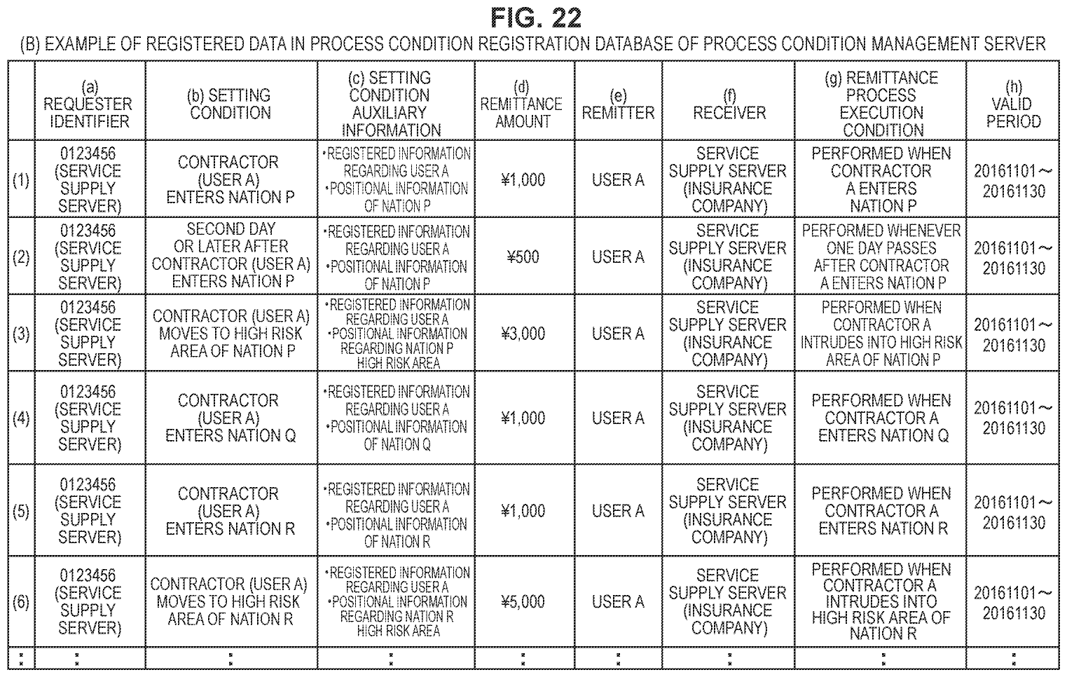

FIG. 22 illustrates example of a plurality of process conditions registered in the process condition registration database 31 of the process condition management server.

As illustrated in FIG. 22, for example, the following conditions can be defined as the “(b) setting condition” and the “(g) remittance process execution condition” in the process conditions.

(1) A setting condition=the contractor (the user A) enters Nation P.

A remittance process execution condition=performed when the contractor A enters Nation P.

(2) A setting condition=the second day or later after the contractor (the user A) enters Nation P.

A remittance process execution condition=performed whenever one day passes after the contractor A enters Nation P.

(3) A setting condition=the contractor (the user A) moves to a high risk area of Nation P.

A remittance process execution condition=performed when the contractor A intrudes into a high risk area of Nation P.

(4) A setting condition=the contractor (the user A) enters Nation Q.

A remittance process execution condition=performed when the contractor A enters Nation Q.

(5) A setting condition=the contractor (the user A) enters Nation R.

A remittance process execution condition=performed when the contractor A enters Nation R.

(6) A setting condition=the contractor (the user A) mores to a high risk area of Nation R.

A remittance process execution condition=performed when the contractor A intrudes into a high risk area of Nation R.

In this way, the setting condition, the remittance process execution condition, the remitter, the receiver, the remittance amount, and the like can be variously set.

Note that there are various users who are acquisition targets of the positional information or the behavioral information set as the setting condition, and the process management server 30 selects a user who is an acquisition target of the positional information or the behavioral information in accordance with a condition included in the setting condition and performs a process of acquiring information (position/behavior) from a portable terminal or the like of the selected user.

Note that in the above-described embodiment, the example in which the service supply server 200 is the server for the insurance company and the price payment based on the insurance contract of the user A 10 is performed has been described, but the embodiment is not limited to the insurance contract and may be applied to price payment for other various services.

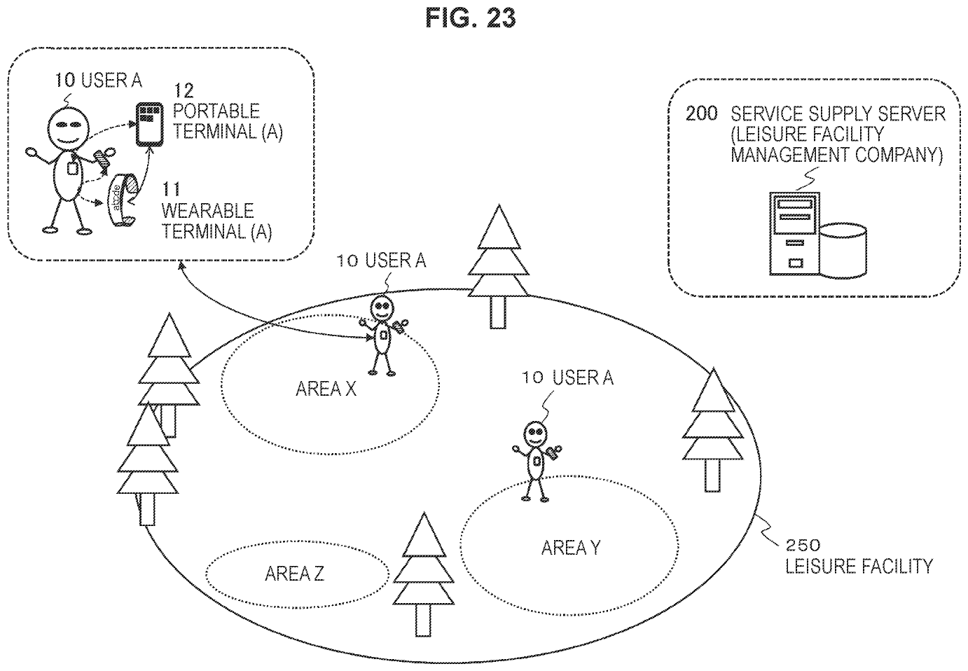

A different service price payment example from the insurance will be described with reference to FIG. 23.

FIG. 23 is an explanatory diagram illustrating a process example in which a use fare of a leisure facility 250 is charged from a user.

The user A 10 uses various facilities of various areas of the leisure facility 250, areas X, Y, and Z illustrated in FIG. 23.

The user A 10 mounts or holds the wearable terminal (A) 11 and the portable terminal (A) 12 described in the above-described embodiment.

The user A 10 registers the user information in the leisure facility management company that supplies leisure facility use services at the time of entry into the leisure facility 250, that is, suggests account information such as the electronic money account of the user by which a use fare can be paid as user information and makes a use contract.

In the use contract, both checks that a predetermined fare is paid from the account of the user in a case in which the user intrudes into each service zone (X, Y, Z, and the like).

The leisure facility management company registers the account information of the user in the service supply server 200 and transmits the process condition information including a price payment condition based on the position or behavior of the user from the service supply server 200 to the process condition management server 30.

The process condition management server 30 registers the process condition information received from the service supply server 200 in the process condition registration database 31.

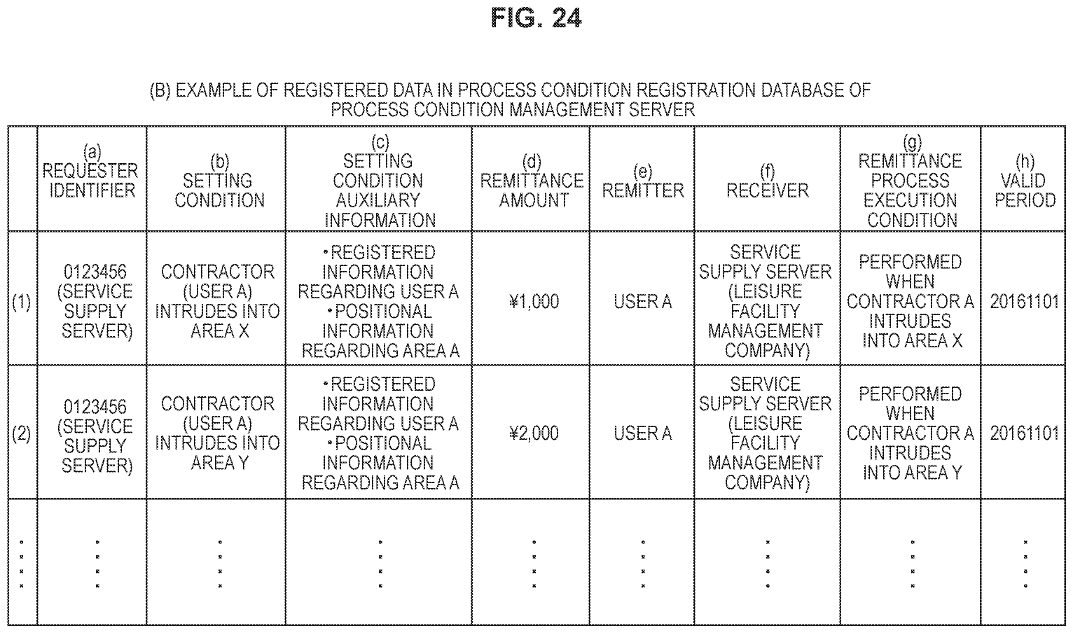

Examples of data registered in the process condition registration database 31 are illustrated in FIG. 24.

For example, the following setting conditions and remittance process execution conditions are registered.

(1) A setting condition=the contractor (the user A) introduces into the area X.

A remittance process execution condition=performed when the contractor A introduces into the area X.

(2) A setting condition=the contractor (the user A) introduces into the area Y.

A remittance process execution condition=performed when the contractor A introduces into the area Y.

The process condition management server 30 performs communication with the wearable terminal (A) 11 or the portable terminal (A) 12 of the user A 10 and determines whether or not the position or the behavior of the user satisfies the setting condition of the registered data illustrated in FIG. 24.

In a case in which it is determined that the position or the behavior satisfies the setting condition, a remittance request is output to the process execution server 40 that manages the accounts of the users.

In response to the remittance request, the process execution server 40 remits the use fare from the account of the user A 10 to the account of the leisure facility management company which is the service supply company.

By performing such a process, the user A 10 can use each area freely without performing, for example, a troublesome process of approaching the terminal with the electronic money function to a terminal of an area gate and performing fare payment when the user A 10 enters each area.

### 4. Configuration Example of Information Processing Device

Next, a hardware configuration example of each of the information processing devices included in the information processing system according to the present disclosure will be described with reference to FIG. 23 and the subsequent drawing.

FIG. 23 is a block diagram illustrating configuration examples of the wearable terminals 11 and 21 and the portable terminals 12 and 22 held or worn by the users.

The portable terminals 12 and 22 each include a control unit 301, an authentication processing unit 302, a sensor unit 303, a display unit 304, a clocking unit 305, an input unit (manipulation unit) 306, an output unit 307, a storage unit 308, and a communication unit 309.

The control unit 301 performs general control for various processes performed by each constituent unit and control such as data transmission and reception control for data processing performed in the wearable terminals 11 and 21. The control unit 301 includes a CPU that has a program execution function and performs a process or the like in accordance with an application (program) stored in the storage unit 308.

For example, the process or the like in accordance with the sequence described above is performed.

Specifically, for example, the control unit 301 performs a transaction with electronic money associated with user accounts of a financial institution such as a bank.

In addition, the control unit 301 performs a process of transmitting the information acquired by the biometric information acquisition sensor and the positional sensor or the behavioral sensor to the process condition management server. Further, the control unit 301 performs a process or the like of receiving, via the communication unit 309, a result of a transaction process with electronic money performed on conditions (a) and (b) below:

(a) checking that user authentication based on the biometric information in the process condition management server is established; and

(b) checking that the positional information or the behavioral information satisfies a setting condition retained in the process condition management server.

The authentication processing unit 302 performs an authentication process. Specifically, the authentication processing unit 302 performs a process of acquiring biometric information necessary for the authentication process and a series of processes necessary in an authentication process sequence with an external device. Note that a biometric information acquisition sensor included in the sensor unit 303 can be applied to the process of acquiring the biometric information. In addition, in the authentication process with the external device, transmission and reception or the like of authentication data is performed using the communication unit 309.

The sensor unit 303 includes the following two constituent elements:

a biometric information acquisitions sensor; and

a positional or behavioral information acquisition sensor.

The two elements are included.

The biometric information acquisitions sensor is configured to have at least one biometric information acquisition function of, for example, a blood vessel detection function, an iris detection function, an image photographing function, and the like. The sensor acquisition information is input to the authentication processing unit 302 and is supplied to an external device via the communication unit 309, and then the user authentication process is performed.

The positional or behavioral information acquisition sensor includes a sensor that detects a position or a behavior of the user. For example, the positional or behavioral information acquisition sensor includes various sensors such as a positional information detection sensor, an acceleration sensor, and a barometric sensor.

The positional information detection sensor includes, for example, a GPS sensor, a beacon detection unit, and the like and is preferably a sensor that has a configuration capable of detecting a position irrespective of indoor and outdoor places.

The barometric sensor is used to detect a position at which the user is located vertically. For example, a position regarding meters from the ground is acquired as data.

The positional information detected by each sensor is transmitted to an external device, for example, the process condition management server 30, via the communication unit 309.

The acceleration sensor can detect, for example, a behavior of the user and specifically detect that the user is running, is moving swing his or her hand to the upper and lower sides or the right and left, or the like and acquires motion information of the user. The motion information is transmitted to an external device, for example, the process condition management server 30, via the communication unit 309.

The display unit 304 also functions as an input unit for a display process for various kinds of information or of a touch panel type.

The clocking unit 305 includes, for example, a timer function or the like of measuring an elapsed time from a certain set time in addition to a clock function of showing current time information.

The input unit 306 is an input unit which can be manipulated by the user and is an input unit that performs various manipulation instructions or the like. The display unit of a touch panel type is also a part of the input unit.

The output unit 307 is configured for an image output, a sound output, and others and includes a data output unit or the like for an external device. The display unit 304 is also one of the constituent elements of the output unit 307.

The storage unit 308 includes a RAM, a ROM, other recording media, and the like.

The storage unit 308 is used as a storage region for various kinds of data. The storage unit 308 is also used as a storage region of an application program to be executed by the control unit 301. Further, the storage unit 308 is also used as a storage region or a work region of parameters or the like applied to data processing to be performed by the control unit 301.

The communication unit 309 is a communication unit that performs communication with the wearable terminals 11 and 21 or an external device such as an external server. The communication unit 309 is used for data communication via various communication paths such as Wi-Fi and Bluetooth (registered trademark) (BT).

On the other hand, the wearable terminals 11 and 21 also each include a control unit 321, an authentication processing unit 322, a sensor unit 323, a display unit 324, a clocking unit 325, an input unit (manipulation unit) 326, an output unit 327, a storage unit 328, and a communication unit 329 as in the portable terminals 12 and 22.

The functions are basically similar to those of the portable terminals 12 and 22.

Here, the communication unit 329 of the wearable terminals 11 and 21 may have, for example, only a Bluetooth (registered trademark) (BT) communication function applied to communication with the portable terminals 12 and 22. Specifically, the communication unit 329 may be configured to perform data communication in conformity with the Blutooth (registered trademark) low energy standard which is a low power consumption type Bluetooth (registered trademark) (BT: Bluetooth (registered trademark)) communication.

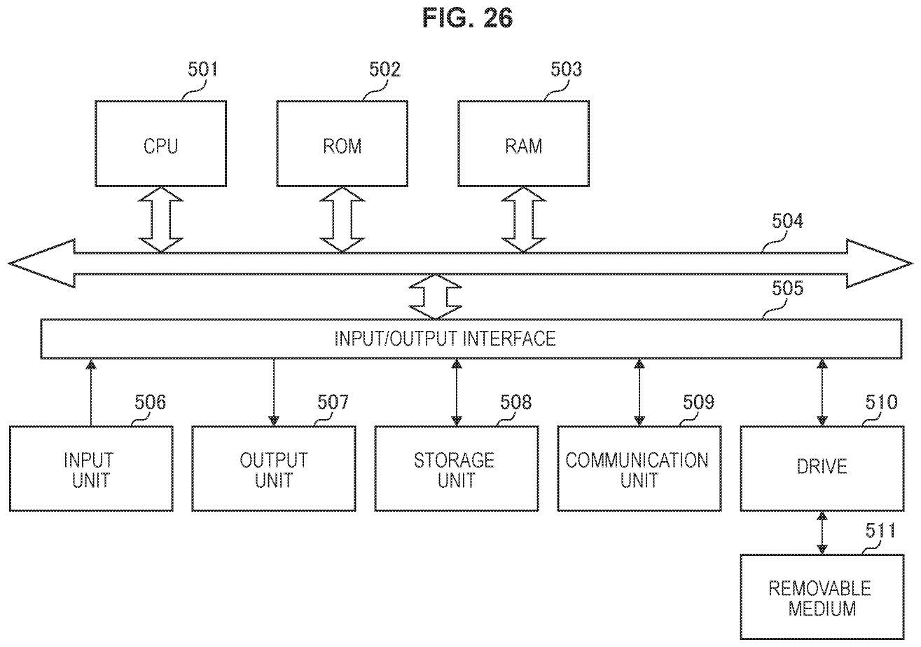

Next, a hardware configuration example of the information processing device which can be used as the server included in the information processing system according to the present disclosure will be described with reference to FIG. 26.

A central processing unit (CPU) 501 functions as a control unit and a data processing unit that executes various processes in accordance with a program stored in read-only memory (ROM) 502 or a storage unit 508. For example, processes following the sequences described in the embodiment described above are executed. Random access memory (RAM) 503 stores programs executed by the CPU 501, data, and the like. The CPU 501, ROM 502, and RAM 503 are interconnected by a bus 504.

The CPU 501 is connected to an input/output interface 505 via the bus 504. Connected to the input/output interface 505 are an input unit 506, which includes various switches, a keyboard, a mouse, a microphone, and the like, and an output unit 507, which includes a display, speakers, and the like. The CPU 501 executes various processes in response to commands input from the input unit 506, and outputs processing results to the output unit 507, for example.

A storage unit 508 connected to the input/output interface 505 includes a hard disk or the like, for example, and stores programs executed by the CPU 501 and various data. A communication unit 509 functions as a transmitting/receiving unit for Wi-Fi communication, Bluetooth® (BT) communication, or some other data communication via a network such as the Internet or a local area network, and communicates with external apparatus.

A drive 510 connected to the input/output interface 505 drives a removable medium 511 such as a magnetic disk, an optical disc, a magneto-optical disc, or semiconductor memory such as a memory card, and executes the recording or reading of data.

### 5. Summary of Configuration of Present Disclosure

The foregoing thus provides a detailed explanation of embodiments of the present disclosure with reference to specific embodiments. However, it is obvious that persons skilled in the art may make modifications and substitutions to these embodiments without departing from the gist of the present disclosure. In other words, the present disclosure has been disclosed by way of example, and should not be interpreted in a limited manner. The gist of the present disclosure should be determined in consideration of the claims.

Additionally, the present technology may also be configured as below.
(1)

An information processing device including:

a control unit configured to perform a transaction with electronic money associated with a user account;

a biometric information acquisition sensor configured to acquire biometric information; and

a positional sensor or a behavioral sensor configured to acquire positional information or behavioral information,

in which the control unit transmits the information acquired by the biometric information acquisition sensor and the positional sensor or the behavioral sensor to a process condition management server and receives, via the communication unit, a result of a transaction process with electronic money performed on conditions (a) and (b) below:

(a) checking that user authentication based on the biometric information in the process condition management server is established; and

(b) checking that the positional information or the behavioral information satisfies a setting condition retained in the process condition management server.
(2)

The information processing device according to (1), in which the control unit receives a remittance process result on the user account as the result of the transaction process via the communication unit.
(3)

The information processing device according to (1), in which the control unit receives a payment process result from the user account as the result of the transaction process via the communication unit.
(4)

The information processing device according to any of (1) to (3), in which the control unit continuously transmits the positional information or the behavioral information acquired by the positional sensor or the behavioral sensor to the process condition management server.
(5)

The information processing device according to any of (1) to (4), in which the control unit continuously transmits the biometric information acquired by the biometric information acquisition sensor to the process condition management server.
(6)

The information processing device according to any of (1) to (5), in which the transaction process is a remittance process or a payment process performed in accordance with process condition information registered in the process condition management server.
(7)

The information processing device according to (6), in which the process condition information includes information regarding each of a remittance amount, a remitter, and a receiver and the transaction process is performed in accordance with the remittance amount, the remitter, and the receiver recorded in the process condition information.
(8)

The information processing device according to any of (1) to (7),

in which the setting condition registered in the process condition management server includes positional information of a user who wears or holds the information processing device, and

the transaction process is performed on the basis of checking of agreement of the positional information transmitted to the process condition management server with the positional information recorded in the setting condition.
(9)

The information processing device according to any of (1) to (8),

in which the setting condition registered in the process condition management server includes behavioral information of a user who wears or holds the information processing device, and

the transaction process is performed on the basis of checking of agreement of the behavioral information transmitted to the process condition management server with the behavioral information recorded in the setting condition.
(10)

The information processing device according to any of (1) to (9), in which the biometric information acquisition sensor is configured to acquire biometric information regarding at least one of a fingerprint, a vein, a face, an iris, a blood vessel, or a voiceprint.
(11)

The information processing device according to any of (1) to (10), in which the positional sensor includes at least one of a GPS sensor or a barometric sensor.
(12)

The information processing device according to any of (1) to (11), in which the behavioral sensor includes an acceleration sensor.
(13)

The information processing device according to any of (1) to (12), in which the information processing device is a wearable terminal mountable on a body of a user.
(14)

The information processing device according to any of (1) to (13), in which the information processing device is a wristband type wearable terminal mountable on an arm of a user.
(15)

The information processing device according to any of (1) to (12), in which the information processing device is a portable terminal that transmits information received from a wearable terminal to the process condition management server.
(16)

An information processing device including:

a communication unit configured to perform communication with a user terminal that performs a transaction with electronic money associated with a user account; and

a data processing unit configured to perform data processing to which data received from the user terminal via the communication unit is applied,

in which the data processing unit performs user authentication based on biometric information received from the user terminal, and

in a case in which the user authentication is established, the data processing unit determines whether or not positional information or behavioral information received from the user terminal satisfies a setting condition registered in a storage unit, and performs a remittance process to the user account or a payment process from the user account or outputs a request for a transaction process to a process execution server in accordance with a transaction aspect registered in advance on the basis of the determination of the satisfaction.
(17)

An information processing system including:

a user terminal; and

a process condition management server,

in which the user terminal includes a control unit that performs a transaction with electronic money associated with a user account, a biometric information acquisition sensor that acquires biometric information, and a positional sensor or a behavioral sensor that acquires positional information or behavioral information,

the control unit performs a process of transmitting the information acquired by the biometric information acquisition sensor and the positional sensor or the behavioral sensor to the process condition management server,

the process condition management server performs user authentication based on the biometric information received from the user terminal, and

in a case in which the user authentication is established, the process condition management server determines whether or not positional information or behavioral information received from the user terminal satisfies a setting condition registered in a storage unit, and performs a remittance process to the user account or a payment process from the user account or outputs a request for a transaction process in accordance with a transaction aspect registered in advance to a process execution server on the basis of the determination of the satisfaction.
(18)

An information processing system including:

a user terminal;

a process condition management server; and

a process execution server,

in which the user terminal includes a control unit that performs a transaction with electronic money associated with a user account, a biometric information acquisition sensor that acquires biometric information, and a positional sensor or a behavioral sensor that acquires positional information or behavioral information,

the control unit performs a process of transmitting the information acquired by the biometric information acquisition sensor and the positional sensor or the behavioral sensor to the process condition management server,

the process condition management server performs user authentication based on the biometric information received from the user terminal,

in a case in which the user authentication is established, the process condition management server determines whether or not positional information or behavioral information received from the user terminal satisfies a setting condition registered in a storage unit, and outputs a request for a transaction process in accordance with a transaction aspect registered in advance to a process execution server on the basis of the determination of the satisfaction, and

the process execution server performs a remittance process to the user account or a payment process from the user account in accordance with the transaction aspect registered in advance in response to reception of the request for performing the transaction process from the process condition management server.
(19)

An information processing method performed by an information processing device,

in which the information processing device includes a control unit configured to perform a transaction with electronic money associated with a user account, a biometric information acquisition sensor configured to acquire biometric information, and a positional sensor or a behavioral sensor configured to acquire positional information or behavioral information, and

the control unit transmits the information acquired by the biometric information acquisition sensor and the positional sensor or the behavioral sensor to a process condition management server and receives, via the communication unit, a result of a transaction process with electronic money performed on conditions (a) and (b) below:

(a) checking that user authentication based on the biometric information in the process condition management server is established; and

(b) checking that the positional information or the behavioral information satisfies a setting condition retained in the process condition management server.
(20)

A program causing an information processing device to perform information processing,

in which the information processing device includes a control unit configured to perform a transaction with electronic money associated with a user account, a biometric information acquisition sensor configured to acquire biometric information, and a positional sensor or a behavioral sensor configured to acquire positional information or behavioral information, and

the program causes the control unit to control a process of transmitting the information acquired by the biometric information acquisition sensor and the positional sensor or the behavioral sensor to a process condition management server and a process of receiving, via the communication unit, a result of a transaction process with electronic money performed on conditions (a) and (b) below:

(a) checking that user authentication based on the biometric information in the process condition management server is established; and

(b) checking that the positional information or the behavioral information satisfies a setting condition retained in the process condition management server.

In addition, it is possible to execute the series of processes described in this specification by hardware, by software, or by a compound configuration of both. In the case of executing processes by software, a program stating a processing sequence may be installed onto memory in a computer built into special-purpose hardware and executed, or alternatively, the program may be installed and executed on a general-purpose computer capable of executed various types of processes. For example, the program may be prerecorded onto a recording medium. Besides installing the program onto a computer from a recording medium, the program may also be received via a network such as a local area network (LAN) or the Internet, and installed onto a built-in recording medium such as a hard disk.

Note that the various processes described in the specification not only may be executed in a time series in the order described, but may also be executed in parallel or individually according to the processing performance of the device executing the process, or as needed. Also, in this specification, the term “system” refers to a logical aggregate configuration of multiple devices, and the respective devices of the configuration are not limited to being inside the same housing.

### INDUSTRIAL APPLICABILITY

According to a configuration of an embodiment of the present disclosure as described above, a configuration in which user authentication based on biometric information is performed and a remittance process is performed on the basis of checking that a position or a behavior of a user satisfies a setting condition is realized. Specifically, for example, in an information processing system including a user terminal and a process condition management server, the user terminal includes a control unit that performs a transaction with electronic money associated with a user account and transmits information acquired by a biometric information acquisition sensor and a positional sensor or a behavioral sensor to the process condition management server. The process condition management server performs user authentication based on biometric information, and further determines whether or not the positional or behavioral information satisfies a setting condition, and causes a transaction process in accordance with a registered transaction aspect, for example, a remittance process to the user account to be performed in a case in which the positional or behavioral information satisfies the setting condition.

In the configuration, a configuration in which the user authentication based on the biometric information is performed and the remittance process is realized on the basis that it is checked that a position or a behavior of a user satisfies the setting condition is realized.

### REFERENCE SIGNS LIST

10 user A
11 wearable terminal
12 portable terminal
20 user B
21 wearable terminal
22 portable terminal
30 process condition management server
31 process condition registration database
40 process execution server
81 credit card management server
82 bank management server
83 electronic money management server
101 credit card supporting application
102 bank supporting application
103 electronic money supporting application
104 process condition supporting application
200 service supply server
301, 321 control unit
302, 322 authentication processing unit
303, 323 sensor unit
304, 324 display unit
305, 325 clocking unit
306, 326 input unit (manipulation unit)
307, 327 output unit
308, 328 storage unit
309, 329 communication unit
501 CPU
502 ROM
503 RAM
504 bus
505 input/output interface
506 input unit
507 output unit
508 storage unit
509 communication unit
510 drive
511 removable medium

1. An information processing device comprising:
a control unit configured to perform a transaction with electronic money associated with a user account;
a biometric information acquisition sensor configured to acquire biometric information; and
a positional sensor or a behavioral sensor configured to acquire positional information or behavioral information,
wherein the control unit transmits the information acquired by the biometric information acquisition sensor and the positional sensor or the behavioral sensor to a process condition management server and receives, via the communication unit, a result of a transaction process with electronic money performed on conditions (a) and (b) below:
(a) checking that user authentication based on the biometric information in the process condition management server is established; and
(b) checking that the positional information or the behavioral information satisfies a setting condition retained in the process condition management server.

2. The information processing device according to claim 1, wherein the control unit receives a remittance process result on the user account as the result of the transaction process via the communication unit.

3. The information processing device according to claim 1, wherein the control unit receives a payment process result from the user account as the result of the transaction process via the communication unit.

4. The information processing device according to claim 1, wherein the control unit continuously transmits the positional information or the behavioral information acquired by the positional sensor or the behavioral sensor to the process condition management server.

5. The information processing device according to claim 1, wherein the control unit continuously transmits the biometric information acquired by the biometric information acquisition sensor to the process condition management server.

6. The information processing device according to claim 1, wherein the transaction process is a remittance process or a payment process performed in accordance with process condition information registered in the process condition management server.

7. The information processing device according to claim 6, wherein the process condition information includes information regarding each of a remittance amount, a remitter, and a receiver and the transaction process is performed in accordance with the remittance amount, the remitter, and the receiver recorded in the process condition information.

8. The information processing device according to claim 1,
wherein the setting condition registered in the process condition management server includes positional information of a user who wears or holds the information processing device, and
the transaction process is performed on a basis of checking of agreement of the positional information transmitted to the process condition management server with the positional information recorded in the setting condition.

9. The information processing device according to claim 1,
wherein the setting condition registered in the process condition management server includes behavioral information of a user who wears or holds the information processing device, and
the transaction process is performed on a basis of checking of agreement of the behavioral information transmitted to the process condition management server with the behavioral information recorded in the setting condition.

10. The information processing device according to claim 1, wherein the biometric information acquisition sensor is configured to acquire biometric information regarding at least one of a fingerprint, a vein, a face, an iris, a blood vessel, or a voiceprint.

11. The information processing device according to claim 1, wherein the positional sensor includes at least one of a GPS sensor or a barometric sensor.

12. The information processing device according to claim 1, wherein the behavioral sensor includes an acceleration sensor.

13. The information processing device according to claim 1, wherein the information processing device is a wearable terminal mountable on a body of a user.

14. The information processing device according to claim 1, wherein the information processing device is a wristband type wearable terminal mountable on an arm of a user.

15. The information processing device according to claim 1, wherein the information processing device is a portable terminal that transmits information received from a wearable terminal to the process condition management server.

16. An information processing device comprising:
a communication unit configured to perform communication with a user terminal that performs a transaction with electronic money associated with a user account; and
a data processing unit configured to perform data processing to which data received from the user terminal via the communication unit is applied,
wherein the data processing unit performs user authentication based on biometric information received from the user terminal, and
in a case in which the user authentication is established, the data processing unit determines whether or not positional information or behavioral information received from the user terminal satisfies a setting condition registered in a storage unit, and performs a remittance process to the user account or a payment process from the user account or outputs a request for a transaction process to a process execution server in accordance with a transaction aspect registered in advance on a basis of the determination of the satisfaction.

17. An information processing system comprising:
a user terminal; and
a process condition management server,
wherein the user terminal includes a control unit that performs a transaction with electronic money associated with a user account, a biometric information acquisition sensor that acquires biometric information, and a positional sensor or a behavioral sensor that acquires positional information or behavioral information,
the control unit performs a process of transmitting the information acquired by the biometric information acquisition sensor and the positional sensor or the behavioral sensor to the process condition management server,
the process condition management server performs user authentication based on the biometric information received from the user terminal, and
in a case in which the user authentication is established, the process condition management server determines whether or not positional information or behavioral information received from the user terminal satisfies a setting condition registered in a storage unit, and performs a remittance process to the user account or a payment process from the user account or outputs a request for a transaction process in accordance with a transaction aspect registered in advance to a process execution server on a basis of the determination of the satisfaction.

18. An information processing system comprising:
a user terminal;
a process condition management server; and
a process execution server,
wherein the user terminal includes a control unit that performs a transaction with electronic money associated with a user account, a biometric information acquisition sensor that acquires biometric information, and a positional sensor or a behavioral sensor that acquires positional information or behavioral information,
the control unit performs a process of transmitting the information acquired by the biometric information acquisition sensor and the positional sensor or the behavioral sensor to the process condition management server,
the process condition management server performs user authentication based on the biometric information received from the user terminal,
in a case in which the user authentication is established, the process condition management server determines whether or not positional information or behavioral information received from the user terminal satisfies a setting condition registered in a storage unit, and outputs a request for a transaction process in accordance with a transaction aspect registered in advance to a process execution server on a basis of the determination of the satisfaction, and
the process execution server performs a remittance process to the user account or a payment process from the user account in accordance with the transaction aspect registered in advance in response to reception of the request for performing the transaction process from the process condition management server.

19. An information processing method performed by an information processing device,
wherein the information processing device includes a control unit configured to perform a transaction with electronic money associated with a user account, a biometric information acquisition sensor configured to acquire biometric information, and a positional sensor or a behavioral sensor configured to acquire positional information or behavioral information, and
the control unit transmits the information acquired by the biometric information acquisition sensor and the positional sensor or the behavioral sensor to a process condition management server and receives, via the communication unit, a result of a transaction process with electronic money performed on conditions (a) and (b) below:
(a) checking that user authentication based on the biometric information in the process condition management server is established; and
(b) checking that the positional information or the behavioral information satisfies a setting condition retained in the process condition management server.

20. A program causing an information processing device to perform information processing,
wherein the information processing device includes a control unit configured to perform a transaction with electronic money associated with a user account, a biometric information acquisition sensor configured to acquire biometric information, and a positional sensor or a behavioral sensor configured to acquire positional information or behavioral information, and
the program causes the control unit to control a process of transmitting the information acquired by the biometric information acquisition sensor and the positional sensor or the behavioral sensor to a process condition management server and a process of receiving, via the communication unit, a result of a transaction process with electronic money performed on conditions (a) and (b) below:
(a) checking that user authentication based on the biometric information in the process condition management server is established; and
(b) checking that the positional information or the behavioral information satisfies a setting condition retained in the process condition management server.
